(19) United States
(12) Patent Application Publication
(10) Pub. No.: US 2025/0211634 A1
(43) Pub. Date: Jun. 26, 2025

(54) METHOD AND APPARATUS FOR PROCESSING SMF SET MISMATCH

(71) Applicant: TELEFONAKTIEBOLAGET LM ERICSSON (PUBL), Stockholm (SE)

(72) Inventors: Chunbo WANG, SHANGHAI (CN); Yong YANG, KÅLLERED (SE)

(21) Appl. No.: 18/851,939

(22) PCT Filed: Mar. 28, 2023
(86) PCT No.: PCT/CN2023/084283

§ 371 Date: Sep. 27, 2024

Related U.S. Application Data
(63) Continuation of application No. PCT/CN2022/087687, filed on Apr. 19, 2022.
(63) Continuation of application No. PCT/CN2022/083820, filed on Mar. 29, 2022.

(30) Foreign Application Priority Data
Mar. 29, 2022 (WO) PCT/CN2022/083820
Apr. 19, 2022 (WO) PCT/CN2022/087687

(51) Int. Cl. H04L 67/1034; H04L 67/51

(52) U.S. Cl. CPC H04L 67/1034; H04L 67/51

(57) ABSTRACT

Embodiments of the present disclosure provide method and apparatus for processing SMF set mismatch. A method performed by an access and mobility function (AMF) may comprise obtaining third information about whether a resource is exclusively bound to a specific service instance in a first session management function (SMF). The method further may comprise obtaining fourth information about whether a second SMF supports a reselection of an alternative first SMF instance within an SMF set of the first SMF. The method further may comprise detecting that the first SMF is failed. The method further may comprise reselecting an alternative service instance within the SMF set of the first SMF based on the third information and the fourth information.

### TECHNICAL FIELD

The non-limiting and exemplary embodiments of the present disclosure generally relate to the technical field of communications, and specifically to methods and apparatuses for processing SMF (Session Management Function) set mismatch.

### BACKGROUND

This section introduces aspects that may facilitate a better understanding of the disclosure. Accordingly, the statements of this section are to be read in this light and are not to be understood as admissions about what is in the prior art or what is not in the prior art.

In communication networks for example NR (new radio) as defined by 3rd Generation Partnership Project (3GPP), it has introduced NF Set based session resilience that the equivalent control plane network functions (NFs) can be grouped into NF Sets. E.g. several SMF instances are grouped into an SMF Set. NFs within a NF Set are interchangeable because they share the same context data. A NF can be replaced by an alternative NF within the same NF Set in the case of scenarios such as failure, load balancing, load re-balancing, etc.

A SMF can act as SMF, V-SMF (visited SMF), or H-SMF (home SMF) roles for different PDU session contexts. SMF Set concept doesn't distinguish between different SMF roles. When a SMF registers with a SMF Set Id (identifier) in NRF (Network Repository Function), that means the SMF can support SMF set based resilience for all the session contexts established with SMF, V-SMF, or H-SMF roles if the SMF is used for non-roaming (SMF role), or roaming-in (V-SMF role), or roaming-out (H-SMF role) at the same time.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

In order to support SMF set resilience for roaming interworking between VPLMN and HPLMN, it requires both VPLMN (Visited PLMN (Public Land Mobile Network)) and HPLMN (home PLMN) deploy SMF Set and support the resilience function for V-SMF and H-SMF roles.

In a real network deployment, it's unlikely that all the PLMNs deploy SMF Set. It may also happen that the PLMNs deploys SMF Set for non-roaming users. But the SMF Set does not support resilience for roaming users. Or SMF set resilience is not in roaming agreement.

It is not obvious to derive if the peer SMF supports SMF Set and if the peer SMF doesn't provide a binding indication in the request and response message. NRF based service discovery may help, but it leads to at least extra signaling latency, and it can't cover the case that SMF set is deployed for PDU sessions for non-roaming UEs but not for home-routed PDU sessions. When such support of SMF set information is not available, it would lead the PDU sessions served by a failed SMF unnecessarily deleted or left as hanging resource.

In case the VPLMN or HPLMN has different SMF set resilience capabilities or configurations, the network behavior is not specified in the current 3GPP release, the possible mismatch between VPLMN and HPLMN may happen during SMF failure scenarios. The consequence is that it takes time to reactivate all the related PDU sessions and impact on service availability.

For example, V-SMF supports SMF Set but H-SMF doesn't support SMF set, upon detecting V-SMF failure, the H-SMF would delete PDU session locally, while the V-SMF may keep PDU session. The Mobile Terminating service is impacted.

V-SMF doesn't support SMF Set while H-SMF does support SMF Set, upon detecting H-SMF failure, the V-SMF will release affected PDU sessions, this could leave hanging PDU Sessions in the alternative H-SMF, this will further hang sessions in its upstream node, e.g. PCF.

In 3GPP, the support of SMF (NF) (service) Set is not super clearly defined, however in the applicant's opinion, it contains at least two aspects for a supporting SMF (NF).
1) All resource contexts served by the SMF may be shared by at least one more SMFs in the same SMF (service) Set or its backup SMF, so that in case of SMF failure, the peer entity can select alternative one when detecting the SMF has failed.
2) The SMF can reselect an alternative peer entity based on the binding indication provided by the peer entity, or the NF profile of the peer entity registered in the NRF when the SMF detects that peer entity has failed.

In an embodiment, as long as the SMF supports bullet 2, it can claim it supports SMF Set feature.

However, it seems reasonable to consider the case when the SMF supports only bullet 2, so it may be allowed to claim its support SMF set, since, apparently, support of bullet 2 from implementation is much easier than to support bullet 1, support bullet 1 requires larger change in both software and hardware.

However, imagine the following scenario: if the H-SMF doesn't support any resilience, i.e. its resource is bound only to a specific NF service instance, however since it can reselect another V-SMF if V-SMF has failed, so it will indicate its support to SETFRI.

So, when this H-SMF fails, the peer SMF (V-SMF) may not trigger restoration immediately after detecting the failure of the HI-SMF, and the peer SMF will do so only when there is a signaling message to be sent for a PDU session towards that failed H-SMF. But when the peer V-SMF looks for alternative HI-SMF, it finds there is no alternative H-SMF.

In fact, the PDU session in that H-SMF are deleted, all PDU sessions served by this H-SMF are suffering not possible to receive any mobile terminating service, and massive hanging resource in the V-SMF and AMF.

To overcome or mitigate at least one of above mentioned problems or other problems, a new solution for processing SMF set mismatch is needed.

In a first aspect of the disclosure, there is provided a method performed by an access and mobility function (AMF). The method may comprise obtaining third information about whether a resource is exclusively bound to a specific service instance in a first session management function (SMF). The method further may comprise obtaining fourth information about whether a second SMF supports a reselection of an alternative first SMF instance within an SMF set of the first SMF. The method further may comprise detecting that the first SMF is failed. The method further may comprise reselecting an alternative service instance within the SMF set of the first SMF based on the third information and the fourth information.

In an embodiment, the third information may be a Boolean and/or the fourth information may be a Boolean.

In an embodiment, obtaining the third information may comprise sending a network function (NF) discovery request to a Network Repository Function (NRF) and receiving a NF discovery response comprising the third information from the NRF.

In an embodiment, obtaining the third information may comprise receiving a service response message or a service request message including the third information from the first SMF.

In an embodiment, obtaining the fourth information may comprise sending a NF discovery request to an NRF and receiving a NF discovery response comprising the fourth information from the NRF.

In an embodiment, obtaining the fourth information may comprise receiving an update session management (SM) Context Response message including the fourth information from the first SMF.

In an embodiment, the reselecting an alternative service instance within the SMF set of the first SMF based on the third information and the fourth information may comprise when the third information indicates that the resource is not exclusively bound to the specific service instance in the first SMF, and the fourth information indicates that the second SMF supports the reselection of the alternative first SMF instance within the SMF set of the first SMF, reselecting the alternative V-SMF service instance within the SMF set of the first SMF.

In an embodiment, the reselecting an alternative service instance within the SMF set of the first SMF based on the third information and the fourth information may further comprise when the third information indicates that the resource is not exclusively bound to the specific service instance in the first SMF, and the fourth information indicates that the second SMF doesn't support the reselection of the alternative first SMF instance within the SMF set of the first SMF, reselecting the alternative first SMF service instance within the SMF set of the first SMF and sending a request for deleting at least one affected Protocol Data Unit, PDU, session toward a User Equipment, UE to the alternative first SMF.

In an embodiment, the reselecting an alternative service instance within the SMF set of the first SMF based on the third information and the fourth information may comprise when the third information indicates that the resource is exclusively bound to the specific service instance in the first SMF, releasing at least one affected PDU session without reselecting the alternative first SMF service instance.

In an embodiment, the first SMF may be a visited SMF and the second SMF may be a home SMF or the first SMF may be an intermediate SMF and the second SMF may be an anchor SMF.

In an embodiment, the method may further comprises obtaining fifth information about whether a resource is exclusively bound to a specific service instance in the second SMF. The method may further comprise sending the fifth information to the first SMF.

In a second aspect of the disclosure, there is provided a method performed by a first session management function (SMF). The method comprises sending to an AMF third information about whether a resource is exclusively bound to a specific service instance in the first SMF. The method may further comprise sending to the AMF, fourth information about whether a second SMF supports a reselection of an alternative first SMF instance within an SMF set of the first SMF. The third information and the fourth information are used by the AMF to reselect an alternative service instance within the SMF set of the first SMF when the first SMF is failed.

In an embodiment, the fifth information is obtained from an access and mobility function, AMF, or the second SMF.

In an embodiment, the method may further comprise obtaining fifth information about whether a resource is exclusively bound to a specific service instance in a second SMF. The method further comprises obtaining sixth information about whether the first SMF supports a reselection of an alternative second SMF instance within an SMF set of the second SMF.

In an embodiment, the method may further comprise obtaining the fourth information.

In an embodiment, the obtaining the fourth information may comprise receiving the fourth information from the second SMF.

In an embodiment, the third information may be included in a service request or response message.

In an embodiment, the fourth information may be included in an update SM context response message.

In an embodiment, the method may further comprises sending the third information to the second SMF.

In an embodiment, the first SMF may be a visited SMF and the second SMF may be a home SMF or the first SMF may be an intermediate SMF and the second SMF may be an anchor SMF.

In a third aspect of the disclosure, there is provided a method performed by a second session management function (SMF). The method may comprise receiving from a first SMF third information about whether a resource is exclusively bound to a specific service instance in the first SMF. The method may further comprise obtaining fourth information about whether the second SMF supports a reselection of an alternative first SMF instance within an SMF set of the first SMF.

In an embodiment, the method may further comprise sending fifth information about whether a resource is exclusively bound to a specific service instance in the second SMF to the first SMF.

In an embodiment, the first SMF may be a visited SMF and the second SMF may be a home SMF or the first SMF may be an intermediate SMF and the second SMF may be an anchor SMF.

In a fourth aspect of the disclosure, there is provided an access and mobility function (AMF). The AMF comprises a processor and a memory coupled to the processor. Said memory contains instructions executable by said processor. Said AMF is operative to obtain third information about whether a resource is exclusively bound to a specific service instance in a first session management function (SMF). Said AMF is further operative to obtain fourth information about whether a second SMF supports a reselection of an alternative first SMF instance within an SMF set of the first SMF. Said AMF is further operative to detect that the first SMF is failed. Said AMF is further operative to reselect an alternative service instance within the SMF set of the first SMF based on the third information and the fourth information.

In a fifth aspect of the disclosure, there is provided a first session management function (SMF). The first SMF comprises a processor and a memory coupled to the processor. Said memory contains instructions executable by said processor. Said first SMF is operative to send to an AMF third information about whether a resource is exclusively bound to a specific service instance in the first SMF. Said first SMF is further operative to send to the AMF fourth information about whether a second SMF supports a reselection of an alternative first SMF instance within an SMF set of the first SMF. The third information and the fourth information may be used by the AMF to reselect an alternative service instance within the SMF set of the first SMF when the first SMF is failed.

In a sixth aspect of the disclosure, there is provided a second session management function (SMF). The second SMF comprises a processor and a memory coupled to the processor. Said memory contains instructions executable by said processor. Said second SMF is operative to receive from a first SMF third information about whether a resource is exclusively bound to a specific service instance in the first SMF. Said second SMF is further operative to obtain fourth information about whether the second SMF supports a reselection of an alternative first SMF instance within an SMF set of the first SMF.

In a seventh aspect of the disclosure, there is provided an AMF. The AMF comprises a first obtaining module configured to obtain third information about whether a resource is exclusively bound to a specific service instance in a first session management function (SMF). In an embodiment, the AMF further comprises a second obtaining module configured to obtain fourth information about whether a second SMF supports a reselection of an alternative first SMF instance within an SMF set of the first SMF. The AMF further comprises a detecting module configured to detect that the first SMF is failed. The AMF further comprises a reselecting module configured to reselect an alternative service instance within the SMF set of the first SMF based on the third information and the fourth information.

In an embodiment, the AMF may further comprise a third obtaining module configured to obtain fifth information about whether a resource is exclusively bound to a specific service instance in the second SMF.

In an embodiment, the AMF may further comprise a sending module configured to send the fifth information to the first SMF.

In an eighth aspect of the disclosure, there is provided a first SMF. The first SMF may comprise a first sending module configured to send to an AMF third information about whether a resource is exclusively bound to a specific service instance in the first SMF. The first SMF may further comprise a second sending module configured to send to the AMF, fourth information about whether a second SMF supports a reselection of an alternative first SMF instance within an SMF set of the first SMF.

In an embodiment, the third information and the fourth information may be used by the AMF to reselect an alternative service instance within the SMF set of the first SMF when the first SMF is failed.

In an embodiment, the first SMF may further comprise a first obtaining module configured to obtain fifth information about whether a resource is exclusively bound to a specific service instance in a second SMF. The first SMF may further comprise a second obtaining module configured to obtain sixth information about whether the first SMF supports a reselection of an alternative second SMF instance within an SMF set of the second SMF.

In an embodiment, the first SMF may further comprise a third obtaining module configured to obtaining the fourth information.

In an embodiment, the first SMF may further comprise a third sending module configured to send the third information to the second SMF.

In a ninth aspect of the disclosure, there is provided a second SMF. The second SMF may comprise a receiving module configured to receive from a first SMF third information about whether a resource is exclusively bound to a specific service instance in the first SMF. The second SMF may further comprise an obtaining module configured to obtain fourth information about whether the second SMF supports a reselection of an alternative first SMF instance within an SMF set of the first SMF

In an embodiment, the second SMF may further comprise a sending module configured to send fifth information about whether a resource is exclusively bound to a specific service instance in the second SMF to the first SMF.

In another aspect of the disclosure, there is provided a computer program product comprising instructions which when executed by at least one processor, cause the at least one processor to perform the method according to any one of the first, second or third aspects.

In another aspect of the disclosure, there is provided a computer-readable storage medium storing instructions which when executed by at least one processor, cause the at least one processor to perform the method according to any one of the first, second or third aspects.

Embodiments herein may provide many advantages, of which a non-exhaustive list of examples follows. In some embodiments herein, it is proposed a restoration procedure to restore PDU sessions affected by a SMF failure. In some embodiments herein, it may reduce the time to restore PDU sessions affected by a SMF failure. In some embodiments herein, ghost session issue can be solved. In some embodiments herein, service availability can be improved. The embodiments herein are not limited to the features and advantages mentioned above. A person skilled in the art will recognize additional features and advantages upon reading the following detailed description.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a first failure scenario according to an embodiment of the present disclosure;

FIG. 2 shows a second failure scenario according to an embodiment of the present disclosure;

FIG. 3 shows a third failure scenario according to an embodiment of the present disclosure;

FIG. 4 shows a fourth failure scenario according to an embodiment of the present disclosure;

FIG. 5 shows a fifth failure scenario according to an embodiment of the present disclosure;

FIG. 6 shows a sixth failure scenario according to an embodiment of the present disclosure;

FIG. 7 schematically shows a roaming 5G system architecture according to an embodiment of the present disclosure;

FIG. 8 shows a flowchart of a method according to an embodiment of the present disclosure;

FIG. 9 shows a flowchart of obtaining first information about whether the first SMF supports the first capability according to an embodiment of the present disclosure;

FIG. 10 shows a flowchart of obtaining second information about whether the second SMF supports the first capability according to an embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of obtaining third information about whether the first SMF supports a local NF set for the first SMF and a peer NF set for the second SMF according to an embodiment of the present disclosure;

FIG. 14 shows a flowchart of obtaining fourth information about whether the second SMF supports a local NF set for the second SMF and a peer NF set for the first SMF according to an embodiment of the present disclosure;

FIG. 15 shows a flowchart of a method according to another embodiment of the present disclosure;

FIG. 16 shows a flowchart of a method according to another embodiment of the present disclosure;

FIG. 17 shows a flowchart of a method according to another embodiment of the present disclosure;

FIG. 18 shows a flowchart of a method according to another embodiment of the present disclosure;

FIG. 19 shows a flowchart of a method according to another embodiment of the present disclosure;

FIG. 20a shows a flowchart of a method according to another embodiment of the present disclosure;

FIG. 20b shows a flowchart of a method according to another embodiment of the present disclosure;

FIG. 21a shows a flowchart of a method according to another embodiment of the present disclosure;

FIG. 21b shows a flowchart of a method according to another embodiment of the present disclosure;

FIG. 22 shows a flowchart of a method according to another embodiment of the present disclosure;

FIG. 23 shows a flowchart of a method according to another embodiment of the present disclosure;

FIG. 24 shows a flowchart of a method according to another embodiment of the present disclosure;

FIG. 25 shows a flowchart of a method according to another embodiment of the present disclosure;

FIG. 26 shows a flowchart of a method according to another embodiment of the present disclosure;

FIG. 27a shows a flowchart of a method according to another embodiment of the present disclosure;

FIG. 27b shows a flowchart of a method according to another embodiment of the present disclosure;

FIG. 28 shows a flowchart of a method according to another embodiment of the present disclosure;

FIG. 29 shows a flowchart of a method according to another embodiment of the present disclosure;

FIG. 30 shows a flowchart of a method according to another embodiment of the present disclosure;

FIG. 31 shows a flowchart of a method according to another embodiment of the present disclosure;

FIG. 32 shows a flowchart of a method according to another embodiment of the present disclosure;

FIG. 33 shows a flowchart of a method according to another embodiment of the present disclosure;

FIG. 34 shows a flowchart of a method according to another embodiment of the present disclosure;

FIG. 35 shows a flowchart of a method according to another embodiment of the present disclosure;

FIG. 36 shows a flowchart of a method according to another embodiment of the present disclosure;

FIG. 37 shows a flowchart of an example solution for V-SMF failure according to an embodiment of the present disclosure;

FIG. 38 shows a flowchart of an example solution for V-SMF failure according to another embodiment of the present disclosure;

FIG. 39 shows a flowchart of an example solution for V-SMF failure according to another embodiment of the present disclosure;

FIG. 40 shows a flowchart of an example solution for H-SMF failure according to an embodiment of the present disclosure;

FIG. 41 shows a flowchart of an example solution for H-SMF failure according to another embodiment of the present disclosure;

FIG. 42a shows a flowchart of an example solution for H-SMF failure according to another embodiment of the present disclosure;

FIG. 42b shows a flowchart of a method according to another embodiment of the present disclosure;

FIG. 42c shows a flowchart of a method according to another embodiment of the present disclosure;

FIG. 42d shows a flowchart of a method according to another embodiment of the present disclosure;

FIG. 42e shows a flowchart of a method according to another embodiment of the present disclosure;

FIG. 42f shows a flowchart of a method according to another embodiment of the present disclosure;

FIG. 42g shows a flowchart of a method according to another embodiment of the present disclosure;

FIG. 42h shows a flowchart of a method according to another embodiment of the present disclosure;

FIG. 43 is a block diagram showing an apparatus suitable for practicing some embodiments of the disclosure;

FIG. 44 is a block diagram showing an AMF according to an embodiment of the disclosure;

FIG. 45 is a block diagram showing a first SMF according to an embodiment of the disclosure;

FIG. 46 is a block diagram showing a second SMF according to an embodiment of the disclosure;

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable communication standards such as new radio (NR), long term evolution (LTE), LTE-Advanced (LTE-A), wideband code division multiple access (WCDMA), high-speed packet access (HISPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by a standard organization such as 3GPP. For example, the communication protocols may comprise the first generation (1G), 2G, 3G, 4G, 4.5G, 5G communication protocols, and/or any other protocols either currently known or to be developed in the future.

The term “network device” or “network node” or “network function” refers to any suitable network function (NF) which can be implemented in a network element (physical or virtual) of a communication network. For example, the network function can be implemented either as a network element on a dedicated hardware, as a software instance running on a dedicated hardware, or as a virtualized function instantiated on an appropriate platform, e.g. on a cloud infrastructure. For example, the 5G system (5GS) may comprise a plurality of NFs such as AMF (Access and mobility Function), SMF (Session Management Function), AUSF (Authentication Service Function), UDM (Unified Data Management), PCF (Policy Control Function), AF (Application Function), NFF (Network Exposure Function), UPF (User plane Function) and NRF (Network Repository Function), RAN (radio access network), SCP (service communication proxy), NWDAF (network data analytics function), NSSF (Network Slice Selection Function), NSSAAF (Network Slice-Specific Authentication and Authorization Function), etc.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VOIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IoT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

As used herein, the phrase “at least one of A and B” or “at least one of A or B” should be understood to mean “only A, only B, or both A and B.” The phrase “A and/or B” should be understood to mean “only A, only B, or both A and B”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

It is noted that these terms as used in this document are used only for case of description and differentiation among nodes, devices or networks etc. With the development of the technology, other terms with the similar/same meanings may also be used.

In the following description and claims, unless defined otherwise, all technical and scientific terms used herein have the same meaning as commonly understood by one of ordinary skills in the art to which this disclosure belongs.

Although the subject matter described herein focuses on the mismatch issues for V-SMF and H-SMF roaming interworking. But the similar mismatch issue also exists for the scenario where an I-SMF (intermediate SMF) and Anchor-SMF have different resilience capabilities or configurations.

The following mismatch issues may be considered.

V-SMF failure:
VPLMN doesn't deploy SMF Set, no issue.
VPLMN deploys SMF Set and V-SMF support SMF set function
   H-SMF support SMF Set, normal Set handling, no issue.
   H-SMF doesn't support SMF Set (HPLMN may or may not deploy SMF Set for non-roaming users), mismatch between V-SMF and H-SMF
VPLMN deploys SMF Set but V-SMF doesn't support SMF Set function
   H-SMF support SMF Set, mismatch between V-SMF and H-SMF
   H-SMF doesn't support SMF Set (HPLMN may or may not deploy SMF Set for non-roaming users), mismatch between AMF and V-SMF
      H-SMF failure:
HPLMN doesn't deploy SMF Set, no issue.
HPLMN deploys SMF Set and H-SMF support SMF set function
   V-SMF support SMF Set, normal Set handling, no issue.
   V-SMF doesn't support SMF Set (VPLMN may or may not deploy SMF Set for non-roaming users), mismatch between V-SMF and H-SMF.
HPLMN deploys SMF Set but H-SMF doesn't support SMF Set function
   V-SMF support SMF Set, mismatch between V-SMF and H-SMF
   V-SMF doesn't support SMF Set (VPLMN may or may not deploy SMF Set for non-roaming users), mismatch between H-SMF and other NFs (e.g., UDM (Unified Data Management) or PCF (Policy Control Function)) in HPLMN

The following failure scenarios are considered.

V-SMF failure:
1. V-SMF support SMF set for roaming interface (suggest to introduce a new feature for Nsmf_PDUSession service)
   a. H-SMF support SMF set, applying normal SMF set logic, no change.
   b. H-SMF NOT support SMF set, H-SMF can keep context wait for potential restoration triggered by the AMF reselecting another V-SMF in the same set, or delete affected PDU sessions (legacy behavior for H-SMF and AMF). The AMF may request UE to reactivate PDU session based on the local condifuration if the PDU session is to be deleted;
2. V-SMF not support SMF set:
   a. Regardless H-SMF supports SMF set or NOT, H-SMF deletes affected PDU sessions.

To cover 1b and 2a, it would be good to define another new feature, so that AMF and H-SMF would know it is supported.

H-SMF failure:
1. H-SMF not support SMF set, V-SMF releases PDU session
2. H-SMF supports SMF set (suggest to introduce a new feature for Nsmf_PDUSession service)
   a. V-SMF supports SMF set, applying a reselection of another SMF in the same SMF set;
   b. V-SMF NOT support SMF set, V-SMF releases affected PDU sessions.

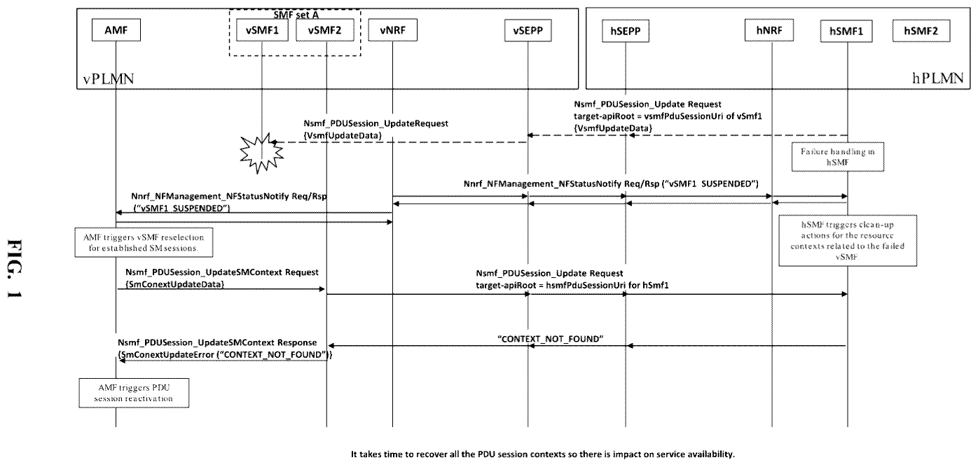

FIG. 1 shows a first failure scenario according to an embodiment of the present disclosure.

In the first failure scenario, VPLMN deploys SMF Set, V-SMF supports SMF Set, and H-SMF doesn't support SMF Set.

As shown in FIG. 1, after detecting V-SMF failure (i.e., vSMF1 failure), H-SMF (i.e., hSMF1) initiates release for the associated PDU sessions if the H-SMF doesn't support SMF Set. But since V-SMF (i.e., vSMF1 failure) supports SMF Set, AMF in VPLMN reselects the other SMF (vSMF2 as an example) in the same SMF Set A, then the reselected vSMF2 restores the SM (session management) contexts and initiates update request to the H-SMF (i.e., hSMF1). Nevertheless, the update request won't be successful as the H-SMF (i.e., hSMF1) has already triggered the release for the corresponding PDU sessions after detecting vSMF1 failure. As vSMF2 has no clue about the PDU session status on the original H-SMF side, so V-SMF2 can only release its local SM context per session basis upon error response from H-SMF (i.e., hSMF1). As a consequence, it takes time to reactivate all the related PDU sessions and impact on service availability.

The messages as shown in FIG. 1 may be same or similar as or to the corresponding messages as described in 3GPP TS 23.502 V17.2.1, the disclosure of which is incorporated by reference herein in its entirety.

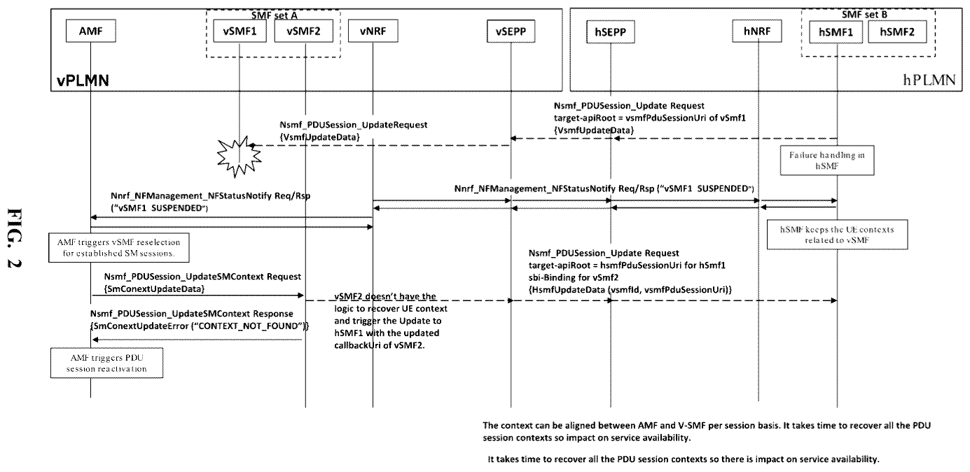

FIG. 2 shows a second failure scenario according to an embodiment of the present disclosure.

In the second failure scenario, VPLMN deploys SMF Set but V-SMF doesn't support SMF Set, and H-SMF supports SMF Sct.

Note that this scenario may happen during the development phase when the SMF vendor in VPLMN has implemented SMF set function for SMF role but not implemented SMF Set function for V-SMF role yet.

As shown in FIG. 2, after detecting vSMF1 failure, AMF in VPLMN reselects the other SMF (vSMF2 as an example) in the same SMF Set A for the established PDU sessions.

AMF sends Nsmf_PDUSession_UpdateSMContext Request to the reselected vSMF2. But the reselected vSMF2 doesn't have the logic to recover session context and trigger a PDU session update request to hSMF1 with the updated callbackUri of vSMF2 as V-SMF doesn't support SMF Set based roaming resilience. Instead, the reselected V-SMF rejects the Nsmf_PDUSession_UpdateSMContext Request with an error response. As a consequence, AMF in VPLMN can only trigger PDU session reactivation per session basis upon error response from v-SMF2, it takes time to reactivate all the related PDU sessions and impact on service availability. There can be also ghost sessions on the original H-SMF if the reactivation selects the H-SMF in a different SMF Set.

The messages as shown in FIG. 2 may be same or similar as or to the corresponding messages as described in 3GPP TS 23.502 V17.2.1, the disclosure of which is incorporated by reference herein in its entirety.

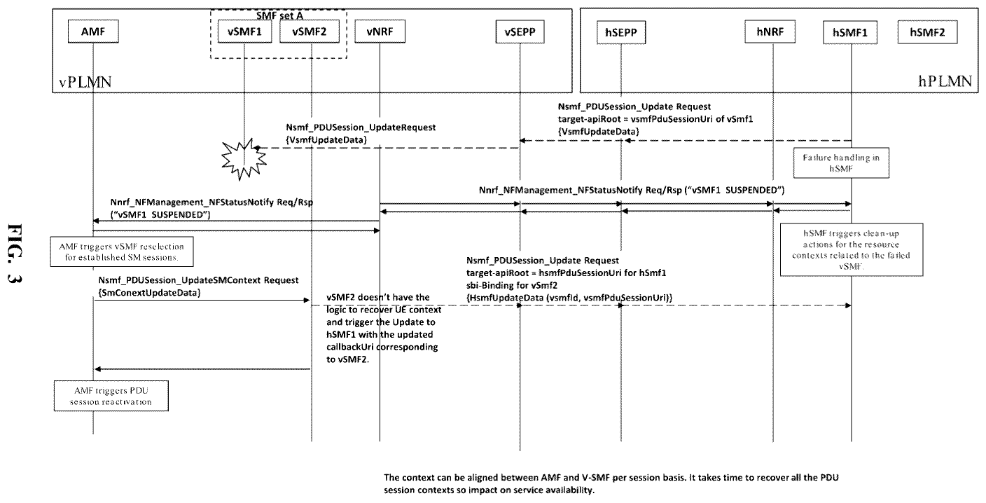

FIG. 3 shows a third failure scenario according to an embodiment of the present disclosure.

In the third failure scenario, VPLMN deploys SMF Set but V-SMF doesn't support SMF Set, and H-SMF doesn't support SMF Sct.

As shown in FIG. 3, the H-SMF initiates release for the associated PDU sessions if the H-SMF doesn't support SMF Set based roaming resilience. As VPLMN deploys SMF Set, AMF in VPLMN reselect another SMF (vSMF2 as an example) in the same SMF Set A. AMF sends Nsmf_PDUSession_UpdateSMContext Request to the reselected vSMF2, Similarly as the second failure scenario, But the reselected vSMF2 doesn't have the logic to recover session context and trigger a PDU session update request to hSMF1 with the updated callbackUri of vSMF2 as V-SMF doesn't support SMF Set based roaming resilience. Instead, the reselected V-SMF rejects the Nsmf_PDUSession_UpdateSMContext Request with an error response. As a consequence, AMF in VPLMN can only trigger PDU session reactivation per session basis upon error response from V-SMF, it takes time to reactivate all the related PDU sessions and impact on service availability.

The messages as shown in FIG. 3 may be same or similar as or to the corresponding messages as described in 3GPP TS 23.502 V17.2.1, the disclosure of which is incorporated by reference herein in its entirety.

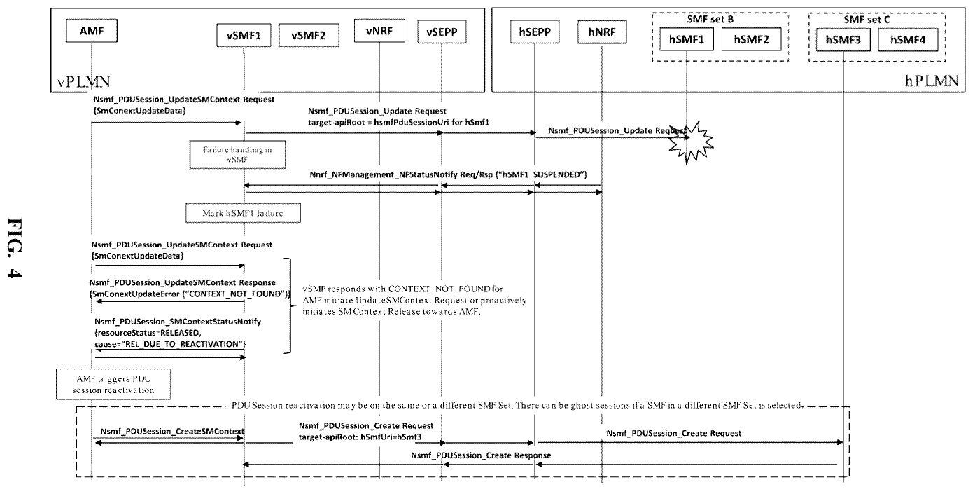

FIG. 4 shows a fourth failure scenario according to an embodiment of the present disclosure.

In the fourth failure scenario, HPLMN deploys SMF Set and H-SMF supports SMF Set, and V-SMF doesn't support SMF Set.

As shown in FIG. 4, when the V-SMF in VPLMN detects that hSMF1 in SMF Set B of HIPLMN fails, the V-SMF for an existing PDU session doesn't reselect the other SMFs in SMF Set B as the V-SMF doesn't support SMF Set function. Instead, the V-SMF triggers SM Context release towards AMF and then AMF will trigger PDU session reactivation. But there can be ghost sessions in SMF Set B if the PDU reactivation selects the SMF in a different SMF Set.

The messages as shown in FIG. 4 may be same or similar as or to the corresponding messages as described in 3GPP TS 23.502 V17.2.1, the disclosure of which is incorporated by reference herein in its entirety.

FIG. 5 shows a fifth failure scenario according to an embodiment of the present disclosure.

In the fifth failure scenario, HIPLMN deploys SMF Set but HI-SMF doesn't support SMF Set, and V-SMF supports SMF Set

This fifth failure scenario may happen during the development phase when the SMF vendor in HPLMN has implemented SMF set function for SMF role but not implemented SMF Set function for H-SMF role yet.

As shown in FIG. 5, there are issues for both VPLMN and HPLMN initiated requests.

In VPLMN, after detecting hSMF1 failure, the V-SMF reselects the other SMF (hSMF2 as an example) in the same SMF Set B for the established PDU sessions and send PDU session update request to the reselected hSMF2. But hSMF2 doesn't have the logic to recover session context so hSMF2 rejects the PDU session update request with “CONTEXT_NOT_FOUND”. As a consequence, AMF in VPLMN can only trigger PDU session reactivation per session basis upon error response from V-SMF, it takes time to reactivate all the related PDU sessions and impact on service availability. There can be also ghost sessions on the original H-SMF if the reactivation selects the H-SMF in a different SMF Sct.

In HPLMN, the surrounding 5GC (5G core network) NFs regards the H-SMF support SMF Set. For example, PCF reselects the other H-SMF in the same SMF Set after detecting hSMF1 failure, but the reselected H-SMF doesn't have the application logic to restore the session context and handle the notification request from PCF. Depending on the implementation, if the H-UPF (home UPF) doesn't release the contexts associated with the failed hSMF1 (i.e., the H-UPF regards hSMF1 in a SMF Set), then the downlink data can arrive V-UPF, and the network triggered service request procedure can be successful. But the call can't be set up as H-SMF doesn't handle the UpdateNotify request (containing the PCC rules for the MT call) from the PCF.

The messages as shown in FIG. 5 may be same or similar as or to the corresponding messages as described in 3GPP TS 23.502 V17.2.1, the disclosure of which is incorporated by reference herein in its entirety.

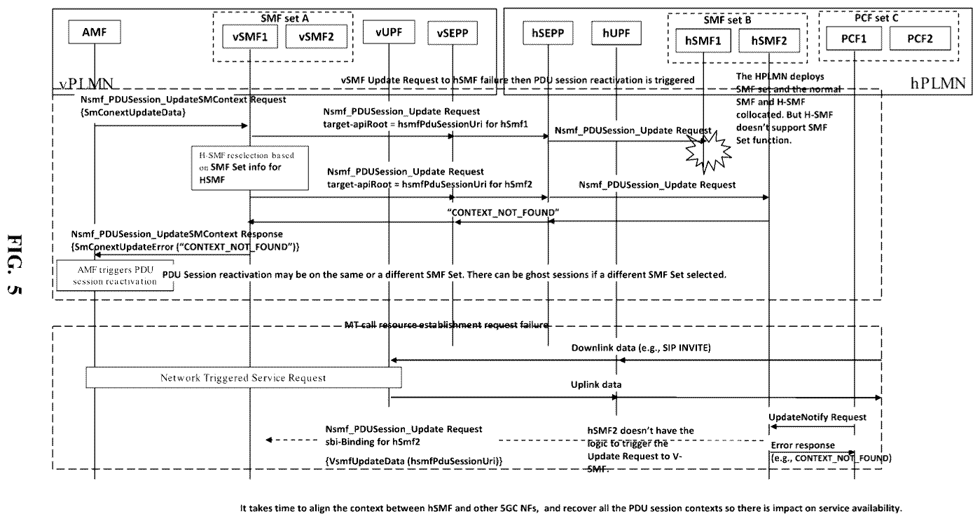

FIG. 6 shows a sixth failure scenario according to an embodiment of the present disclosure.

In the sixth failure scenario, HPLMN deploys SMF Set but H-SMF doesn't support SMF Set, and V-SMF doesn't supports SMF Set.

As shown in FIG. 6, when the vSMF in VPLMN detects that hSMF1 in SMF Sct B of HPLMN fails, the vSMF triggers SM Context release towards AMF and then AMF will trigger PDU session reactivation. But there can be ghost sessions in SMF Set B if the PDU reactivation selects the SMF in a different SMF Set.

Depending on the implementation, if the H-UPF doesn't release the contexts associated with the failed hSMF1 (i.e., the H-UPF regards hSMF1 is in a SMF Set), then the downlink data is sent to the V-UPF (visited V-UPF), but the GTP-U (GPRS (General Packet Radio Service) Tunnelling Protocol for User Plane) error indication will be returned if the vSMF has released the associated context. The H-UPF may send the error indication report to the other available hSMF in SMF Set B. The hSMF behavior is implementation dependent. The hSMF may or may not be able to trigger context clean-up with PCF and other 5GC NFs in HPLMN.

The messages as shown in FIG. 6 may be same or similar as or to the corresponding messages as described in 3GPP TS 23.502 V17.2.1, the disclosure of which is incorporated by reference herein in its entirety.

To overcome or mitigate at least one of above mentioned problems or other problems, it's proposed to introduce roaming resilience indication and restoration indication to negotiate the capability between VPLMN and HPLMN so that the V-SMF and H-SMF can make decision based on the peer capability when V-SMF or H-SMF failure occurs.

In an embodiment, it introduces “vSMF roaming resilience indication” which means V-SMF supports SMF Set based roaming resilience, including both local Set for V-SMF and peer Sct for H-SMF.

In an embodiment, it introduces “hSMF roaming resilience indication” which means H-SMF supports SMF Set based roaming resilience, including both local Set for H-SMF and peer Sct for V-SMF.

In an embodiment, it introduces “vSMF restoration indication” which means the capability of supporting PDU session restoration in case V-SMF failure. It requires AMF, V-SMF and H-SMF all support such capability that PDU session restoration can work in case V-SMF failure.

In an embodiment, if the above indications are not included in the request/response messages and SMF profile, it shall be handled as the corresponding capabilities are not supported for roaming interworking.

In an embodiment, it enable V-SMF and HI-SMF to exchange the information if their resource context is exclusively bound to a specific NF service instance, i.e. no resilience, this can be achieved by the following alternatives as described below.

In an embodiment, through a NF service discovery procedure for a SMF selection, the AMF can determine if the resources served by the candidate V-SMF, or HI-SMF is exclusively bound to a specific NF service instance, i.e. no resilience if there is a failure. It is then proposed that the AMF populate this information to V-SMF and HI-SMF, e.g. in new attributes in Create SmContext Request towards V-SMF, which may be preferably called vSmfNoResilence and hsmfNoResilence, which may be defined as a Boolean, default is 0, then V-SMF shall forward these new attributes in Create PDU session request towards the H-SMF.

In an embodiment, V-SMF includes the new vSmfNoResilence in the Create PDU Session Request message, and H-SMF includes the new hsmfNoResilence in the corresponding response message.

With the proposed solution, it gives the peer SMF clear information if SMF set is supported (at least for the reselection at peer failure) and if the resource it served can be shared by at least one more alternative SMF.

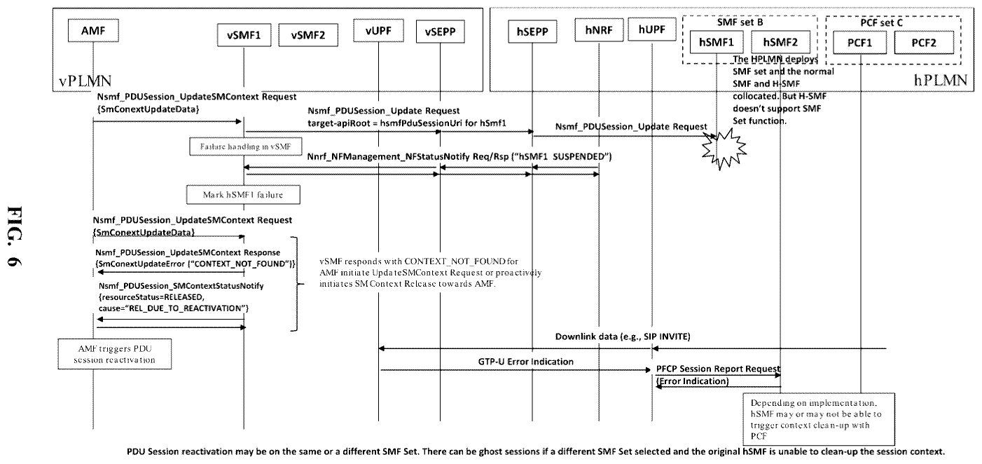

Although the subject matter described herein may be implemented in any appropriate type of system using any suitable components, the embodiments disclosed herein are described in relation to a communication system complied with the exemplary system architecture illustrated in FIG. 7. For simplicity, the system architecture of FIG. 7 only depict some exemplary elements. In practice, a communication system may further include any additional elements suitable to support communication between terminal devices or between a wireless device and another communication device, such as a landline telephone, a service provider, or any other network node or terminal device. The communication system may provide communication and various types of services to one or more terminal devices to facilitate the terminal devices' access to and/or use of the services provided by, or via, the communication system.

FIG. 7 schematically shows a roaming 5G system architecture according to an embodiment of the present disclosure. The architecture of FIG. 7 is same as FIG. 4.2.4-1 as described in 3GPP TS 23.501 V17.2.0, the disclosure of which is incorporated by reference herein in its entirety. The system architecture of FIG. 7 may comprise some exemplary elements such as AUSF, AMF, DN (data network), NFF, NRF, NSSF, PCF, SMF, UDM, UPF, AF, UE, (R)AN, SCP (Service Communication Proxy), NSACF (Network Slice Admission Control Function), vSEPP (visited Security Edge Protection Proxy), hSEPP (home Security Edge Protection Proxy), etc.

In accordance with an exemplary embodiment, the UE can establish a signaling connection with the AMF over the reference point N1, as illustrated in FIG. 7. This signaling connection may enable NAS (Non-access stratum) signaling exchange between the UE and the core network, comprising a signaling connection between the UE and the (R)AN and the N2 connection for this UE between the (R)AN and the AMF. The (R)AN can communicate with the UPF over the reference point N3. The UE can establish a protocol data unit (PDU) session to the DN (data network, e.g. an operator network or Internet) through the UPF over the reference point N6.

As further illustrated in FIG. 7, the exemplary system architecture also contains the service-based interfaces such as Nnrf, Nnef, Nausf, Nudm, Npcf, Namf, Nnsacf and Nsmf exhibited by NFs such as the NRF, the NFF, the AUSF, the UDM, the PCF, the AMF, the NSACF and the SMF. In addition, FIG. 7 also shows some reference points such as N1, N2, N3, N4, N6, N32 and N9, which can support the interactions between NF services in the NFs. For example, these reference points may be realized through corresponding NF service-based interfaces and by specifying some NF service consumers and providers as well as their interactions in order to perform a particular system procedure.

Various NFs shown in FIG. 7 may be responsible for functions such as session management, mobility management, authentication, security, etc. The AUSF, AMF, DN, NFF, NRF, NSSF, PCF, SMF, UDM, UPF, AF, UE, (R)AN, SCP, NSACF may include the functionality for example as defined in clause 6.2 of 3GPP TS 23.501 V17.2.0.

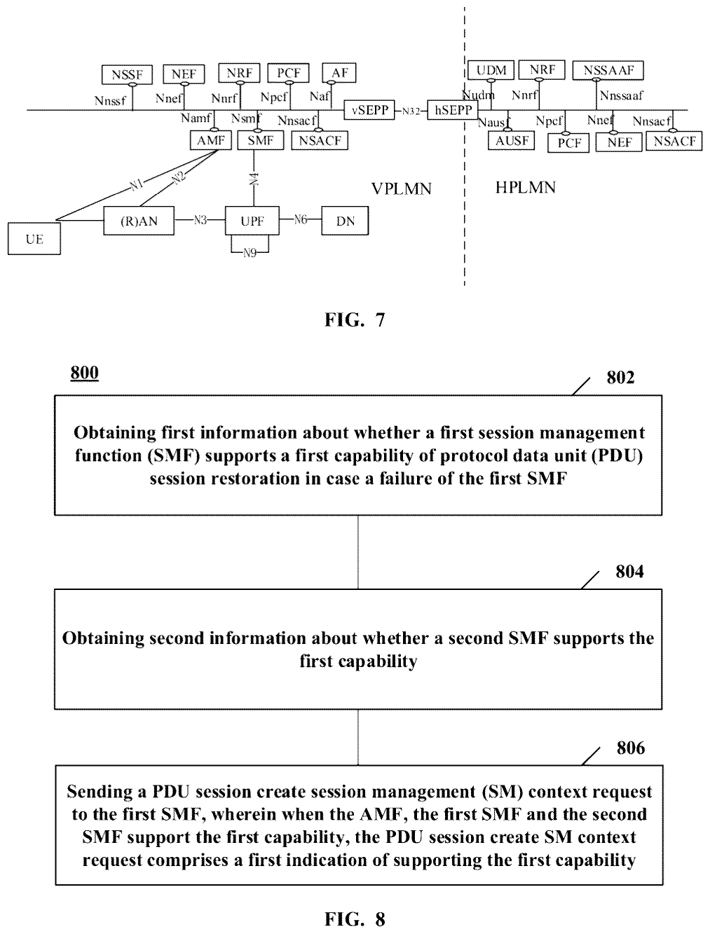

FIG. 8 shows a flowchart of a method according to an embodiment of the present disclosure, which may be performed by an apparatus implemented in or at or as an access and mobility function (AMF) or communicatively coupled to the AMF. As such, the apparatus may provide means or modules for accomplishing various parts of the method 800 as well as means or modules for accomplishing other processes in conjunction with other components.

At block 802, the AMF may obtain first information about whether a first session management function (SMF) supports a first capability of protocol data unit (PDU) session restoration in case a failure of the first SMF.

For example, the first capability may mean the capability of supporting PDU session restoration in case V-SMF failure.

The AMF may obtain the first information in various ways. For example the first SMF may register the first information in NRF. In this case, the AMF may obtain the first information through NRF discovery. As another example, the AMF may obtain the first information from the first SMF when the first SMF may send a message comprising the first information to the AMF. As still another example, the first information may be preconfigured in the network.

At block 804, the AMF may obtain second information about whether a second SMF supports the first capability.

The AMF may obtain the second information in various ways. For example the second SMF may register the second information in NRF. In this case, the AMF may obtain the second information through NRF discovery. As another example, the AMF may obtain the second information from the second SMF when the second SMF may send a message comprising the second information to the AMF. As still another example, the second information may be preconfigured in the network.

At block 806, the AMF may send a PDU session create session management (SM) context request to the first SMF. When the AMF, the first SMF and the second SMF support the first capability, the PDU session create SM context request comprises a first indication of supporting the first capability.

The PDU session create SM context request may create an AMF-SMF association to support a PDU Session. In an embodiment, the PDU session create SM context request may be same or similar as or to the Nsmf_PDUSession_CreateSMContext Request as described in 3GPP TS 23.502 V17.2.1.

In an embodiment, when any one of the AMF, the first SMF or the second SMF does not support the first capability, the first indication is not comprised in the PDU session create SM context request.

FIG. 9 shows a flowchart of obtaining first information about whether the first SMF supports the first capability according to an embodiment of the present disclosure.

In an embodiment, the first SMF may register the first information in NRF.

At block 902, the AMF may send a network function (NF) discovery request to a network repository function (NRF).

At block 904, the AMF may receive a NF discovery response comprising the first information from the NRF.

In an embodiment, the NF discovery request/response may be same as the Nnrf_NFDiscovery_Request and Nnrf_NFDiscovery_Request response as described in 3GPP TS 23.502 V17.2.1.

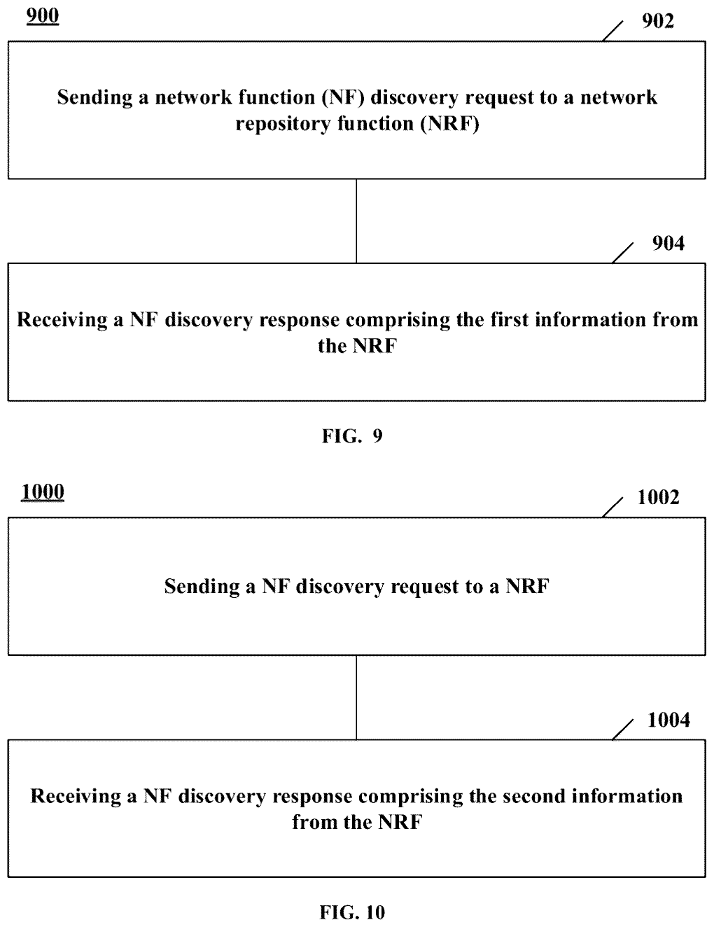

FIG. 10 shows a flowchart of obtaining second information about whether the second SMF supports the first capability according to an embodiment of the present disclosure.

In an embodiment, the second SMF may register the second information in NRF.

At block 1002, the AMF may send a network function (NF) discovery request to a network repository function (NRF).

At block 1004, the AMF may receive a NF discovery response comprising the second information from the NRF.

In an embodiment, the NF discovery request/response may be same as the Nnrf_NFDiscovery_Request and Nnrf_NFDiscovery_Request response as described in 3GPP TS 23.502 V17.2.1.

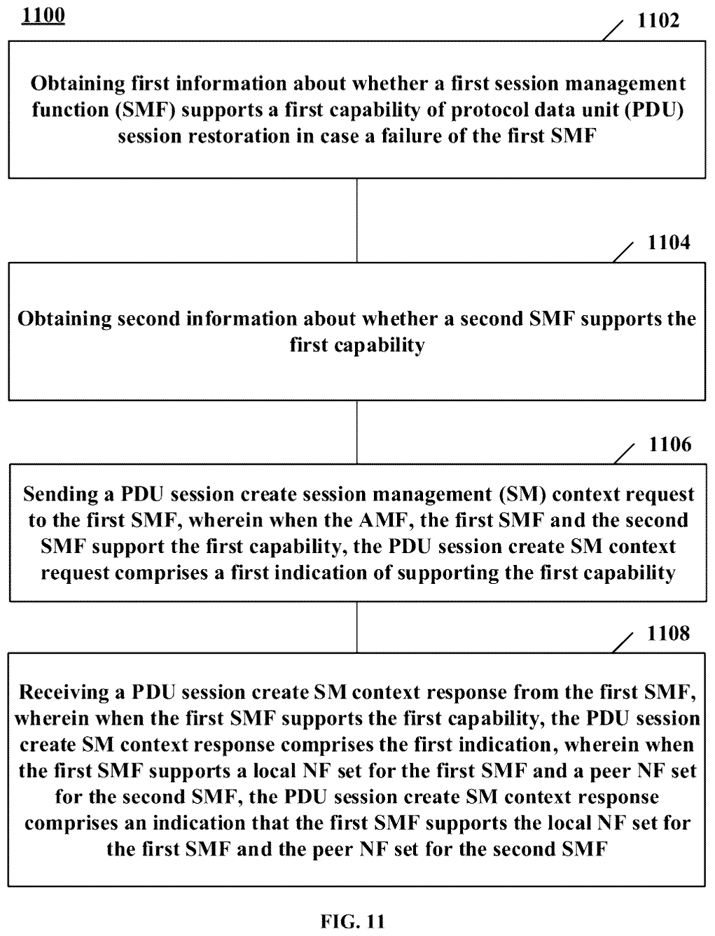

FIG. 11 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1100 as well as means or modules for accomplishing other processes in conjunction with other components. For some parts which have been described in the above embodiments, the description thereof is omitted here for brevity.

At block 1102, the AMF may obtain first information about whether a first SMF supports a first capability of PDU session restoration in case a failure of the first SMF.

At block 1104, the AMF may obtain second information about whether a second SMF supports the first capability.

At block 1106, the AMF may send a PDU session create SM context request to the first SMF. When the AMF, the first SMF and the second SMF support the first capability, the PDU session create SM context request comprises a first indication of supporting the first capability.

At block 1108, the AMF may receive a PDU session create SM context response from the first SMF. When the first SMF supports the first capability, the PDU session create SM context response comprises the first indication. When the first SMF supports a local NF set for the first SMF and a peer NF set for the second SMF, the PDU session create SM context response comprises an indication that the first SMF supports the local NF set for the first SMF and the peer NF set for the second SMF.

Note that since the AMF can obtain the first indication and the indication that the first SMF supports the local NF set for the first SMF and the peer NF set for the second SMF in other ways for example through NRF discovery, PDU session create SM context response may not comprise the first indication and the indication that the first SMF supports the local NF set for the first SMF and the peer NF set for the second SMF in other embodiments.

In an embodiment, when the first SMF supports the local NF set for the first SMF, it may mean that the first SMF supports SMF Set based non-roaming PDU session resilience. For example, when the first SMF is V-SMF and the first SMF supports the local SMF set for the users or UEs in the VPLMN, it means that the first SMF supports SMF Set based non-roaming PDU session resilience.

In an embodiment, when the first SMF supports the peer NF set for the second SMF, it may mean that the first SMF supports SMF Set based roaming PDU session resilience. For example, when the first SMF is V-SMF and the first SMF supports the peer SMF set for the users or UE in HPLMN, it means that the first SMF supports SMF Set based roaming PDU session resilience.

In an embodiment, when the first SMF supports the local NF set for the first SMF, it may mean that the first SMF supports SMF Set based PDU session resilience, where the PDU session is established with the first SMF without other SMF in other network or network slice.

In an embodiment, when the first SMF supports the peer NF set for the second SMF, it may mean that the first SMF supports SMF Set based PDU session resilience, where the PDU session is established with the first SMF and the second SMF.

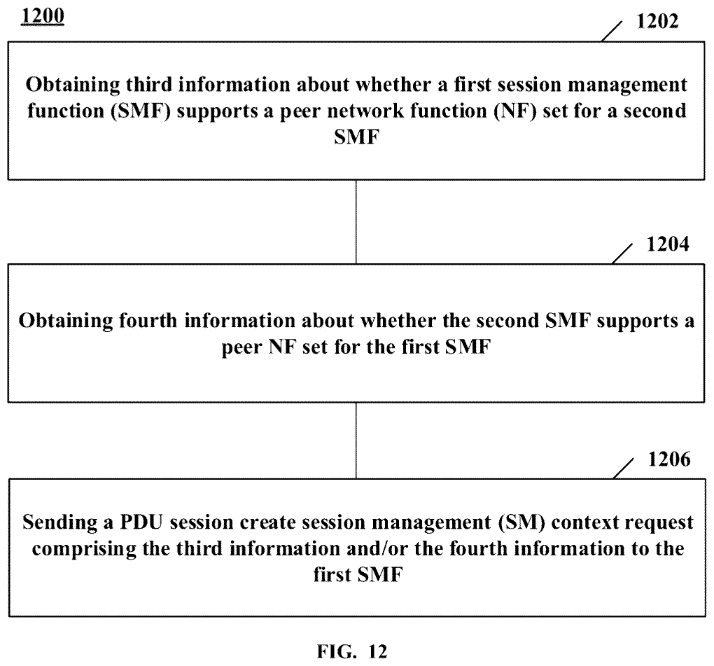

FIG. 12 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1200 as well as means or modules for accomplishing other processes in conjunction with other components. For some parts which have been described in the above embodiments, the description thereof is omitted here for brevity.

At block 1202, the AMF may obtain third information about whether the first SMF supports a peer NF set for the second SMF.

In an embodiment, the AMF may obtain third information about whether the first SMF supports a local NF set for the first SMF and a peer NF set for the second SMF.

The AMF may obtain the third information in various ways. For example the first SMF may register the third information in NRF. In this case, the AMF may obtain the third information through NRF discovery. As another example, the AMF may obtain the third information from the first SMF when the first SMF may send a message comprising the third information to the AMF. As still another example, the third information may be preconfigured in the network.

At block 1204, the AMF may obtain fourth information about whether the second SMF supports a peer NF set for the first SMF.

In an embodiment, the AMF may obtain fourth information about whether the second SMF supports a local network function (NF) set for the second SMF and a peer NF set for the first SMF.

In an embodiment, when the second SMF supports the local NF set for the second SMF, it may mean that the second SMF supports SMF Set based non-roaming PDU session resilience. For example, when the second SMF is H-SMF and the second SMF supports the local SMF set for users or UEs in the HPLMN. It means that the second SMF supports SMF Set based non-roaming PDU session resilience.

In an embodiment, when the second SMF supports the peer NF set for the first SMF, it may mean that the second SMF supports SMF Set based roaming PDU session resilience. For example, when the second SMF is H-SMF and the second SMF supports the peer SMF set for users or UEs in the VPLMN. It means that the second SMF supports SMF Set based roaming PDU session resilience.

In an embodiment, when the second SMF supports the local NF set for the second SMF, it may mean that the second SMF supports SMF Set based PDU session resilience, where the PDU session is established with the second SMF without other SMF in other network or network slice.

In an embodiment, when the second SMF supports the peer NF set for the first SMF, it may mean that the second SMF supports SMF Set based PDU session resilience, where the PDU session is established with the first SMF and the second SMF.

The AMF may obtain the fourth information in various ways. For example the second SMF may register the fourth information in NRF. In this case, the AMF may obtain the fourth information through NRF discovery. As another example, the AMF may obtain the fourth information from the second SMF when the second SMF may send a message comprising the fourth information to the AMF. As still another example, the fourth information may be preconfigured in the network.

At block 1206, the AMF may send a PDU session create session management (SM) context request comprising the third information and/or the fourth information to the first SMF.

In an embodiment, the third information is a Boolean and/or the fourth information is a Boolean.

For example, the third information may be preferably called vSmfNoResilence. The fourth information may be preferably called smfNoResilence. The third information may be defined as a Boolean. Default may be 0. The fourth information may be defined as a Boolean. Default may be 0.

FIG. 13 shows a flowchart of obtaining third information about whether the first SMF supports a local NF set for the first SMF and a peer NF set for the second SMF according to an embodiment of the present disclosure.

In an embodiment, the first SMF may register the third information in NRF.

At block 1302, the AMF may send a network function (NF) discovery request to a network repository function (NRF).

At block 1304, the AMF may receive a NF discovery response comprising the third information from the NRF.

In an embodiment, the NF discovery request/response may be same as the Nnrf_NFDiscovery_Request and Nnrf_NFDiscovery_Request response as described in 3GPP TS 23.502 V17.2.1.

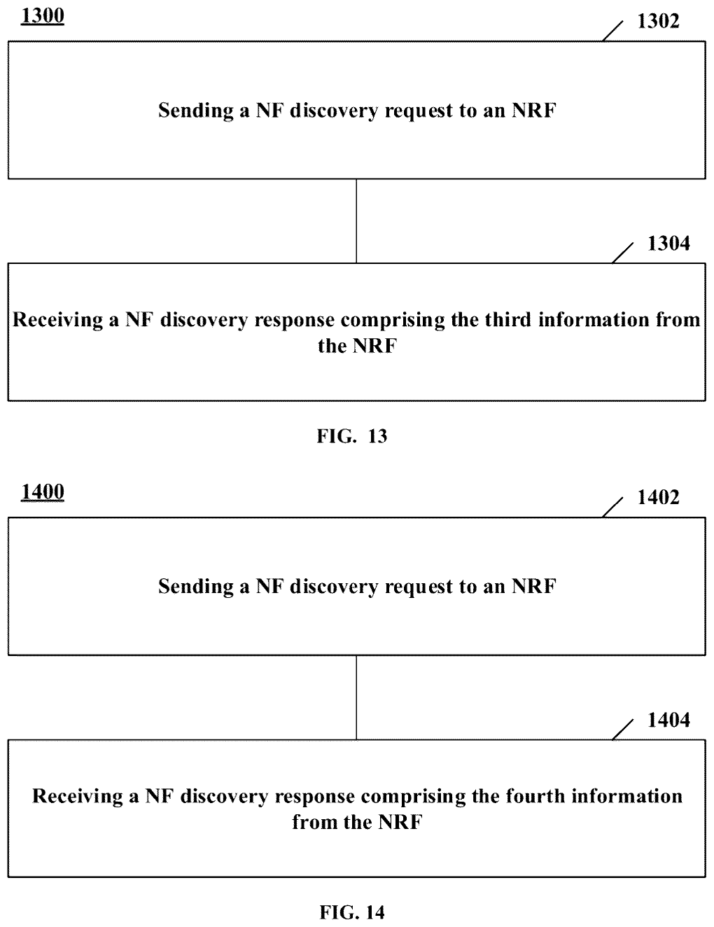

FIG. 14 shows a flowchart of obtaining fourth information about whether the second SMF supports a local NF set for the second SMF and a peer NF set for the first SMF according to an embodiment of the present disclosure.

In an embodiment, the second SMF may register the fourth information in NRF.

At block 1402, the AMF may send a network function (NF) discovery request to a network repository function (NRF).

At block 1404, the AMF may receive a NF discovery response comprising the fourth information from the NRF.

In an embodiment, the NF discovery request/response may be same as the Nnrf_NFDiscovery_Request and Nnrf_NFDiscovery_Request response as described in 3GPP TS 23.502 V17.2.1.

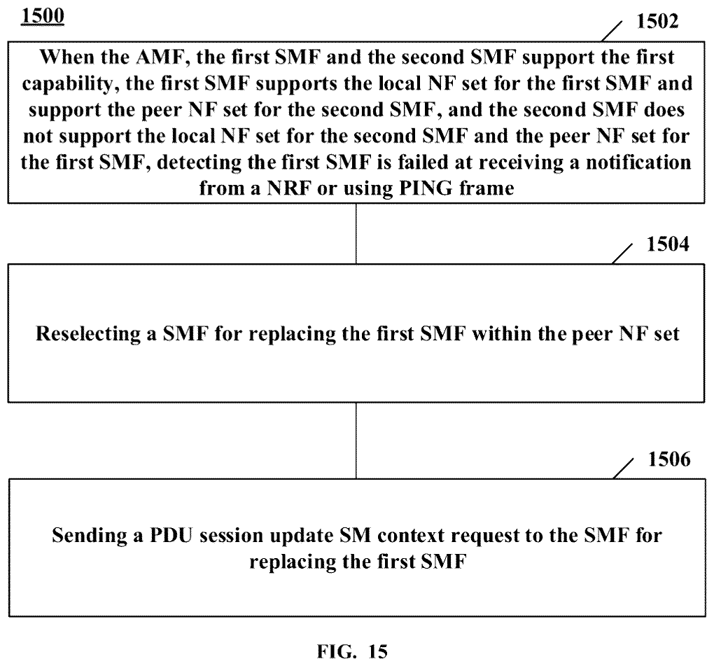

FIG. 15 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1500 as well as means or modules for accomplishing other processes in conjunction with other components. For some parts which have been described in the above embodiments, the description thereof is omitted here for brevity.

In an embodiment, the AMF, the first SMF and the second SMF support the first capability. The first SMF supports the local NF set for the first SMF and support the peer NF set for the second SMF. The second SMF does not support the local NF set for the second SMF and the peer NF set for the first SMF.

At block 1502, the AMF may detect the first SMF is failed at receiving a notification from a NRF or using PING frame. The AMF may receive an NF status notify request comprising information indicating the first SMF is failed from a NRF. For example, the NF status notify request may be Nnrf_NFManagement_NFStatusNotify Request as described in 3GPP TS 23.502 V17.2.1.

At block 1504, the AMF may reselect a SMF for replacing the first SMF within the peer NF set.

At block 1506, the AMF may send a PDU session update SM context request to the SMF for replacing the first SMF. The PDU session update SM context request may be Nsmf_PDUSession_UpdateSMContext Request as described in 3GPP TS 23.502 V17.2.1.

In an embodiment, AMF includes vSMF restoration indication in the CreateSMContext request towards the selected V-SMF, and the V-SMF includes vSMF roaming resilience indication and vSMF restoration indication in PDUSessionCreateRequest towards the HI-SMF.

In an embodiment, when the first SMF failure occurs, the second SMF shall keep the associated PDU sessions and wait for restoration. The AMF triggers first SMF reselection for the established SM contexts in Update Request to trigger restoration, and the reselected first SMF includes the updated vSMFId and vSmfPduSessionUri in the Update Request towards the second SMF.

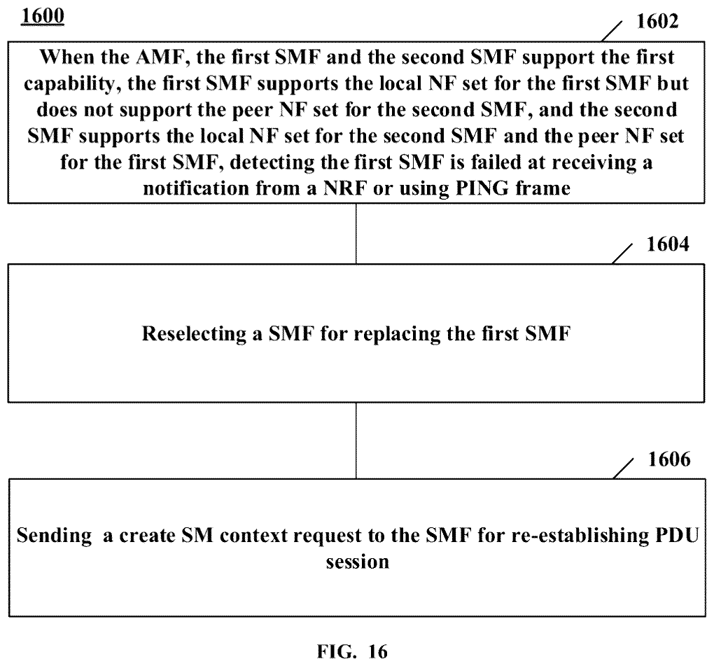

FIG. 16 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1600 as well as means or modules for accomplishing other processes in conjunction with other components. For some parts which have been described in the above embodiments, the description thereof is omitted here for brevity.

In an embodiment, the AMF, the first SMF and the second SMF support the first capability. The first SMF supports the local NF set for the first SMF but does not support the peer NF set for the second SMF. The second SMF supports the local NF set for the second SMF and the peer NF set for the first SMF.

At block 1602, the AMF may detect the first SMF is failed at receiving a notification from a NRF or using PING frame.

At block 1604, the AMF may reselect a SMF for replacing the first SMF.

At block 1606, the AMF may send a create SM context request to the SMF for re-establishing PDU session.

In an embodiment, when the SMF for replacing the first SMF supports the first capability, the PDU session create SM context request comprises the first indication.

In an embodiment, the create SM context request comprises information about whether the reselected SMF supports a peer NF set for the second SMF and/or information about whether the second SMF supports a peer NF set for the reselected SMF.

In an embodiment, AMF includes vSMF restoration indication in the CreateSMContext request towards the selected vSMF. The V-SMF relays the received vSMF restoration indication in PDUSessionCreateRequest towards the H-SMF, but the V-SMF doesn't include vSMF roaming resilience indication and as the vSMF doesn't support SMF Set.

In an embodiment, when the selected V-SMF failure occurs, the H-SMF shall keep the associated PDU sessions and wait for vSMF restoration. The AMF triggers PDU session reactivation to restore the impacted PDU sessions, and the reselected V-SMF sends PDUSessionCreateRequest towards the original H-SMF. The HI-SMF executes Create on Create to accept the new PDU Session Request.

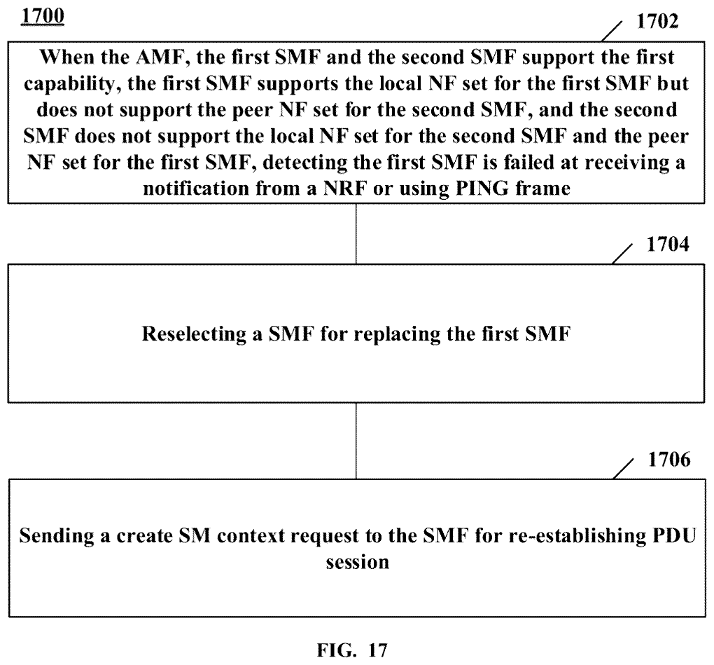

FIG. 17 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1700 as well as means or modules for accomplishing other processes in conjunction with other components. For some parts which have been described in the above embodiments, the description thereof is omitted here for brevity.

In an embodiment, the AMF, the first SMF and the second SMF support the first capability. The first SMF supports the local NF set for the first SMF but does not support the peer NF set for the second SMF. The second SMF does not support the local NF set for the second SMF and the peer NF set for the first SMF.

At block 1702, the AMF may detect the first SMF is failed at receiving a notification from a NRF or using PING frame.

At block 1704, the AMF may reselect a SMF for replacing the first SMF.

At block 1706, the AMF may send a create SM context request to the SMF for re-establishing PDU session.

In an embodiment, the create SM context request comprises information about whether the reselected SMF supports a peer NF set for the second SMF and/or information about whether the second SMF supports a peer NF set for the reselected SMF.

In an embodiment, when the SMF for replacing the first SMF supports the first capability, the PDU session create SM context request comprises the first indication.

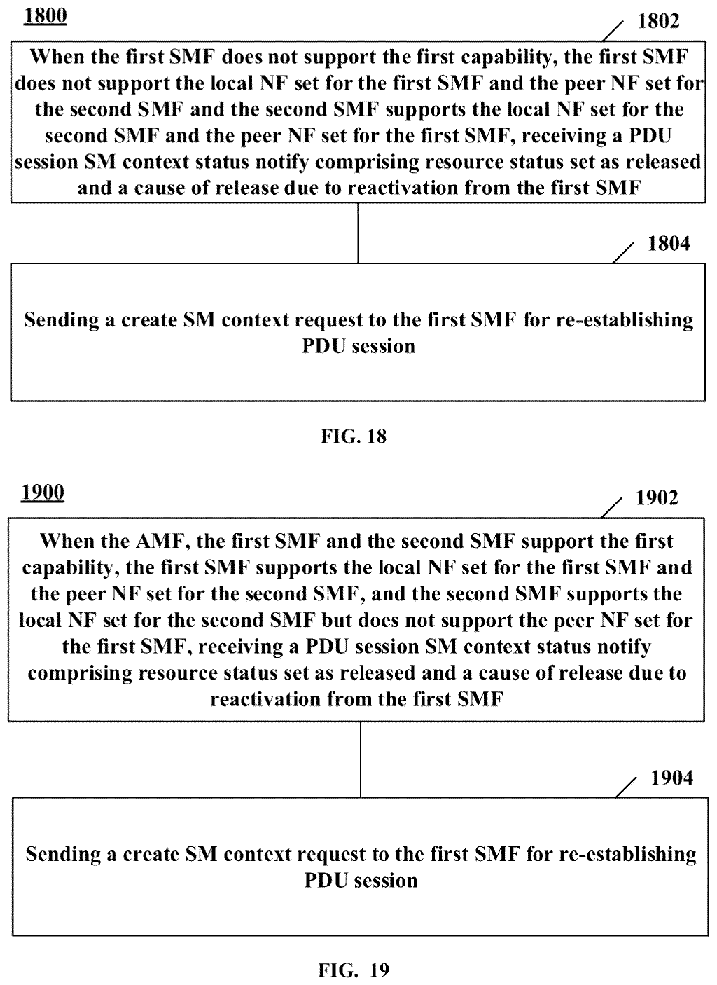

FIG. 18 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1800 as well as means or modules for accomplishing other processes in conjunction with other components. For some parts which have been described in the above embodiments, the description thereof is omitted here for brevity.

In an embodiment, the first SMF does not support the first capability. The first SMF does not support the local NF set for the first SMF and the peer NF set for the second SMF. The second SMF supports the local NF set for the second SMF and the peer NF set for the first SMF.

At block 1802, the AMF may receive a PDU session SM context status notify comprising resource status set as released and a cause of release due to reactivation from the first SMF.

At block 1804, the AMF may send a create SM context request to the first SMF for re-establishing PDU session.

In an embodiment, the create SM context request comprises information about whether the first SMF supports a peer NF set for a reselected second SMF and/or information about whether the reselected second SMF supports a peer NF set for the first SMF.

FIG. 19 shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 1900 as well as means or modules for accomplishing other processes in conjunction with other components. For some parts which have been described in the above embodiments, the description thereof is omitted here for brevity.

In an embodiment, the AMF, the first SMF and the second SMF support the first capability. The first SMF supports the local NF set for the first SMF and the peer NF set for the second SMF. The second SMF supports the local NF set for the second SMF but does not support the peer NF set for the first SMF.

At block 1902, the AMF may receive a PDU session SM context status notify comprising resource status set as released and a cause of release due to reactivation from the first SMF.

At block 1904, the AMF may send a create SM context request to the first SMF for re-establishing PDU session.

In an embodiment, the create SM context request comprises information about whether the first SMF supports a peer NF set for a reselected second SMF and/or information about whether the reselected second SMF supports a peer NF set for the first SMF.

In an embodiment, when the AMF, the first SMF and a reselected SMF for replacing the second SMF support the first capability, the PDU session create SM context request comprises the first indication.

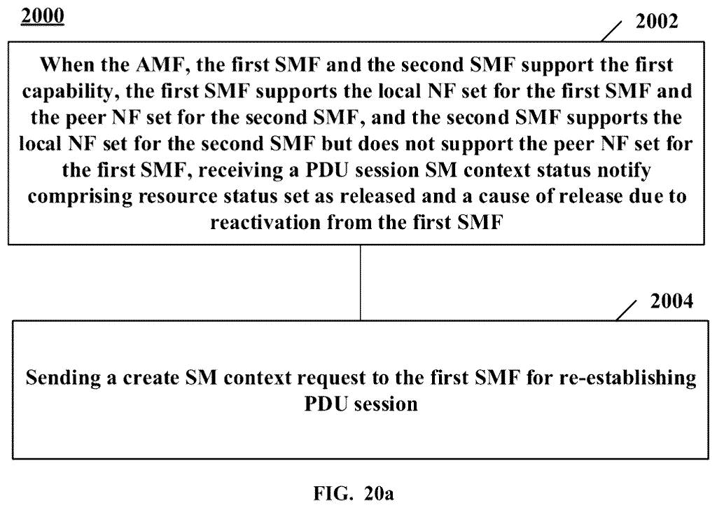

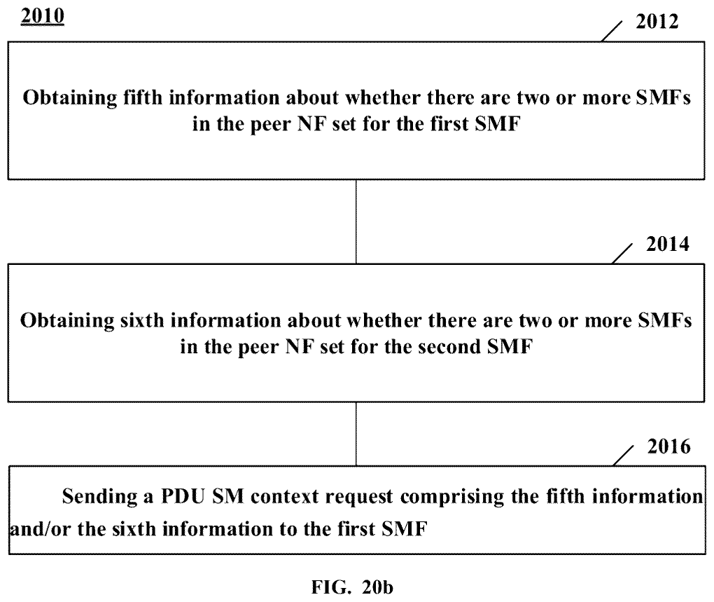

FIG. 20a shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 2000 as well as means or modules for accomplishing other processes in conjunction with other components. For some parts which have been described in the above embodiments, the description thereof is omitted here for brevity.

In an embodiment, the first SMF does not support the first capability. The first SMF does not support the local NF set for the first SMF and the peer NF set for the second SMF. The second SMF supports the local NF set for the second SMF but does not support the peer NF set for the first SMF.

At block 2002, the AMF may receive a PDU session SM context status notify comprising resource status set as released and a cause of release due to reactivation from the first SMF.

At block 2004, the AMF may send a create SM context request to the first SMF for re-establishing PDU session to the first SMF.

In an embodiment, the create SM context request comprises information about whether the first SMF supports a peer NF set for a reselected second SMF and/or information about whether the reselected second SMF supports a peer NF set for the first SMF.

In an embodiment, the first SMF is a visited SMF and the second SMF is a home SMF.

In an embodiment, the first SMF is an intermediate SMF and the second SMF is an anchor SMF.

FIG. 20b shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 2010 as well as means or modules for accomplishing other processes in conjunction with other components. For some parts which have been described in the above embodiments, the description thereof is omitted here for brevity.

At block 2012, the AMF may obtain fifth information about whether there are two or more SMFs in the peer NF set for the first SMF.

At block 2014, the AMF may obtain sixth information about whether there are two or more SMFs in the peer NF set for the second SMF.

At block 2016, the AMF may send a PDU SM context request comprising the fifth information and/or the sixth information to the first SMF.

In an embodiment, the third information and the sixth information are represented by a single parameter and the fourth information and the fifth information are represented by a single parameter.

For example, the roaming resilience indication actually should mean supporting local set and peer set. The new thing to be added is the indication that there are multiple vSMFs in the same vSMF Set and multiple hSMFs in the same hSMF Set. AMF discovers there are multiple vSMFs in the same vSMF Set and/or multiple hSMFs in the hSMF Set, such information is sent by AMF to vSMF. Such information may be referred to as “vSMF set indication” and “hSMF sct indication”. The vSMF relays the vSMF set indication towards hSMF.

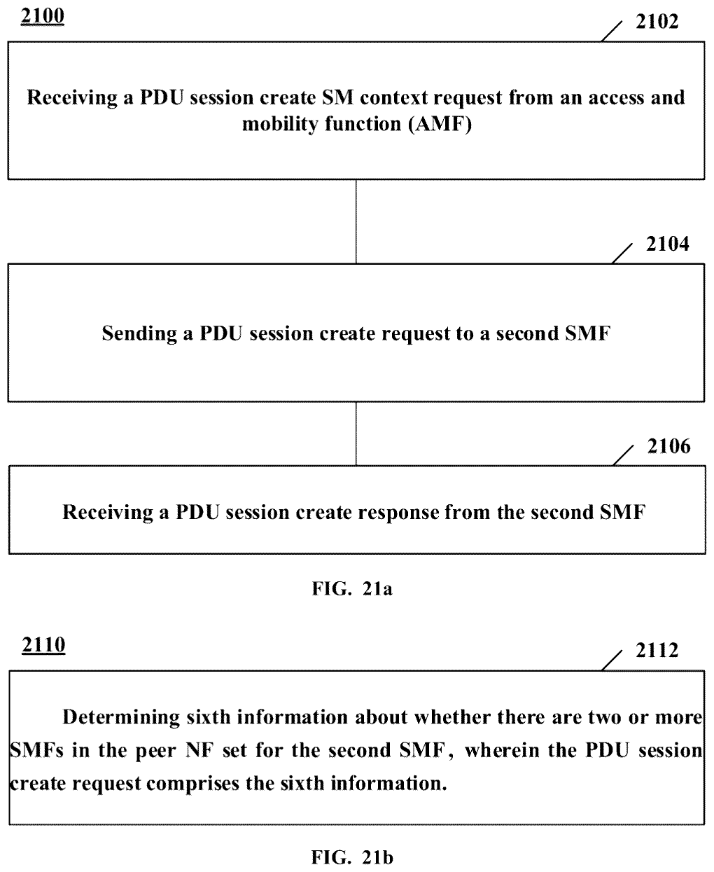

FIG. 21a shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2100 as well as means or modules for accomplishing other processes in conjunction with other components. For some parts which have been described in the above embodiments, the description thereof is omitted here for brevity.

At block 2102, the first SMF may receive a PDU session create SM context request from an access and mobility function (AMF).

At block 2104, the first SMF may send a PDU session create request to a second SMF.

At block 2106, the first SMF may receive a PDU session create response from the second SMF.

In an embodiment, when the AMF, the first SMF and the second SMF support a first capability of PDU session restoration in case a failure of the first SMF, the PDU session create SM context request comprises a first indication of supporting the first capability.

In an embodiment, when the AMF, the first SMF and the second SMF support the first capability, the PDU session create request comprises the first indication.

In an embodiment, when the first SMF supports a local NF set for the first SMF and a peer NF set for the second SMF, the PDU session create request further comprises an indication that the first SMF supports the local NF set for the first SMF and the peer NF set for the second SMF.

In an embodiment, when the AMF, the first SMF and the second SMF support the first capability, the PDU session create response comprises the first indication.

In an embodiment, the first SMF supports the local NF set for the first SMF and the peer NF set for the second SMF and the second SMF supports a local NF set for the second SMF and a peer NF set for the first SMF, the PDU session create response comprises an indication that the second SMF supports the local NF set for the second SMF and the peer NF set for the first SMF.

In an embodiment, when any one of the AMF, the first SMF or the second SMF docs not support the first capability, the first indication is not comprised in the PDU session create SM context request.

In an embodiment, when the second SMF supports a peer NF set for the first SMF, the PDU session create response comprises an indication that the second SMF supports the peer NF set for the first SMF.

In an embodiment, the PDU session create SM context request comprises third information about whether a first session management function (SMF) supports a peer network function (NF) set for a second SMF and/or fourth information about whether the second SMF supports a peer NF set for the first SMF, and the PDU session create request comprises the third information and/or the fourth information.

In an embodiment, the PDU session create request comprises information about whether the first SMF supports peer SMF reselection within a peer SMF set when an original peer SMF instance failure happens.

In an embodiment, the PDU session create response comprises information about whether the second SMF supports peer SMF reselection within a peer SMF set when an original peer SMF instance failure happens.

In some embodiments, in order to make sure roaming resilience working end-to-end, it requires both vSMF and hSMF support its own SMF set and peer SMF set.

In some embodiments, it may call the own SMF set as “roaming resilience indication”, and peer SMF set as “peer v/hSMF set support indication”.

The meaning of the own SMF set (“roaming resilience indication”) has two aspects: (1) support its own session context replication/backup in the other SMF instances of the same Set; (2) itself is deployed in a SMF set (multiple SMF instances available in a SMF pool, so that context replication/switchover can be possible after SMF failure). Note that AMF can discover whether there are multiple instances in the same SMF set/pool when discovering vSMF and hSMF.

The meaning of the “peer SMF set support indication” is a bit simple. It just means the SMF supports the peer SMF reselection within the peer SMF set when the original SMF instance failure happens.

Based on that rationale, in the Create SM context request, AMF sends both “vSMF roaming resilience indication” (own vSMF set) and “hSMF roaming resilience indication” (own hSMF set) to the vSMF, and the vSMF relays that info to hSMF. With such exchange, vSMF knows whether the peer hSMF is deployed in a SMF set and also hSMF knows whether the vSMF is deployed in a SMF set. Note that the “hSMF roaming resilience indication” is a bit redundant between vSMF and hSMF interface as vSMF has already learned that from AMF in Create SM context request. But there is no harm to convey that info in PDU Create Request/Response.

In an embodiment, the third information is a Boolean and/or the fourth information is a Boolean.

In an embodiment, the PDU session create SM context request comprises fifth information about whether there are two or more SMFs in the peer NF set for the first SMF and or sixth information about whether there are two or more SMFs in the peer NF set for the second SMF, and the PDU session create request comprises the fifth information and/or the sixth information.

In an embodiment, the third information and the sixth information are represented by a single parameter and the fourth information and the fifth information are represented by a single parameter.

For example, the roaming resilience indication actually should mean supporting local set and peer set. The new thing to be added is the indication that there are multiple vSMFs in the same vSMF Set and multiple hSMFs in the same hSMF Set. The vSMF and hSMF themselves can also detect such information, the vSMF and hSMF can discover the other members in the same Set based on proprietary implementation mechanism, then the vSMF and hSMF can exchange such information.

There is another possibility which is to extend the concept of “vSMF set indication” and “hSMF set indication” to also cover the meaning of “vSMF roaming resilience indication” and “hSMF roaming resilience indication”. Then it only needs to exchange vSMF set indication” and “hSMF set indication”. That actually makes sense and simple for implementation, because vSMF set indication anyway is based on vSMF resilience indication, the same applies to hSMF. This solution is actually to replace the parameter name resilience indication with set indication, and extend the concept that the “set indication” means supporting local set, peer set and also multiple members in the same set.

FIG. 21b shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2100 as well as means or modules for accomplishing other processes in conjunction with other components. For some parts which have been described in the above embodiments, the description thereof is omitted here for brevity.

At block 2112, the first SMF may determine sixth information about whether there are two or more SMFs in the peer NF set for the second SMF. The PDU session create request comprises the sixth information.

In an embodiment, the PDU session create response comprises fifth information about whether there are two or more SMFs in the peer NF set for the first SMF.

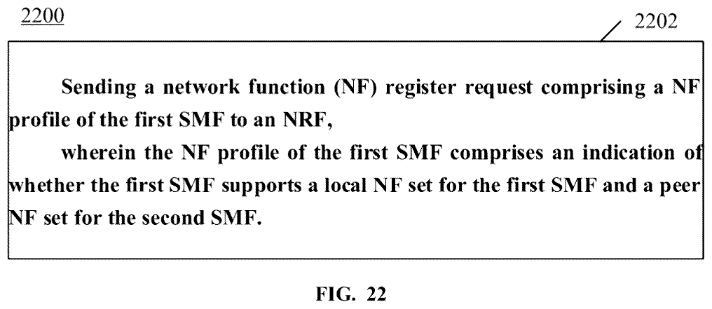

FIG. 22 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2200 as well as means or modules for accomplishing other processes in conjunction with other components. For some parts which have been described in the above embodiments, the description thereof is omitted here for brevity.

At block 2202, the first SMF may send a network function (NF) register request comprising a NF profile of the first SMF to an NRF.

In an embodiment, the NF profile of the first SMF comprises an indication of whether the first SMF supports a capability of PDU session restoration in case a failure of the first SMF.

In an embodiment, the NF profile of the first SMF comprises an indication of whether the first SMF supports a local NF set for the first SMF and a peer NF set for the second SMF.

In an embodiment, the NF profile of the first SMF comprises an indication of whether the first SMF supports a peer NF set for the second SMF (e.g., vSMF roaming resilience indication).

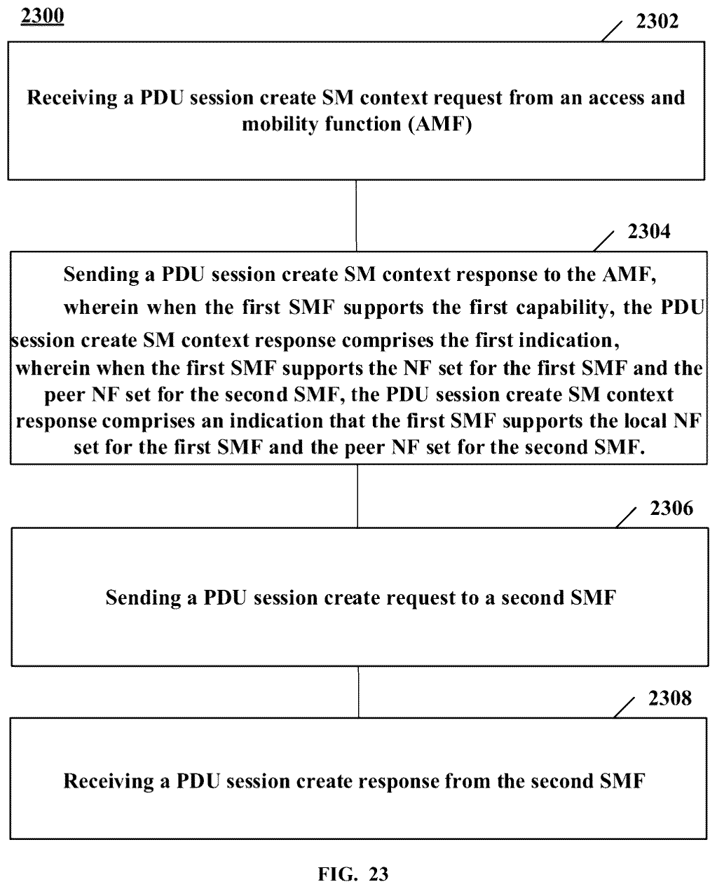

FIG. 23 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2300 as well as means or modules for accomplishing other processes in conjunction with other components. For some parts which have been described in the above embodiments, the description thereof is omitted here for brevity.

At block 2302, the first SMF may receive a PDU session create SM context request from an access and mobility function (AMF). Block 2302 is same as block 2102.

At block 2304, the first SMF may send a PDU session create SM context response to the AMF.

In an embodiment, when the first SMF supports the first capability, the PDU session create SM context response comprises the first indication,

In an embodiment, when the first SMF supports the NF set for the first SMF and the peer NF set for the second SMF, the PDU session create SM context response comprises an indication that the first SMF supports the local NF set for the first SMF and the peer NF set for the second SMF

At block 2306, the first SMF may send a PDU session create request to a second SMF. Block 2306 is same as block 2104.

At block 2308, the first SMF may receive a PDU session create response from the second SMF. Block 2308 is same as block 2106.

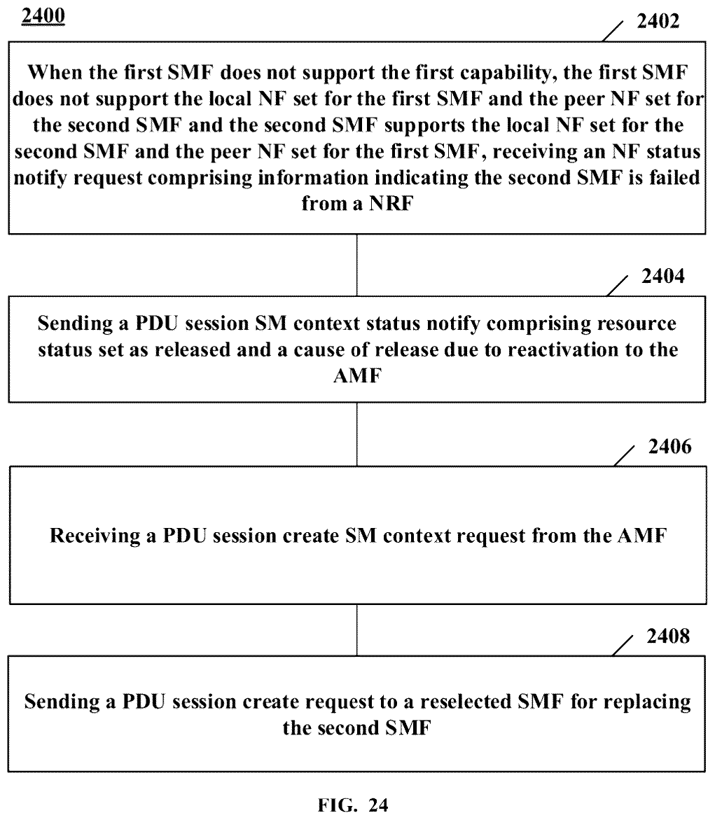

FIG. 24 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2400 as well as means or modules for accomplishing other processes in conjunction with other components. For some parts which have been described in the above embodiments, the description thereof is omitted here for brevity.

In an embodiment, the first SMF does not support the first capability. The first SMF does not support the local NF set for the first SMF and the peer NF set for the second SMF. The second SMF supports the local NF set for the second SMF and the peer NF set for the first SMF.

At block 2402, the first SMF may receive an NF status notify request comprising information indicating the second SMF is failed from a NRF. Alternatively, the first SMF may detecting the second SMF is failed via PING frame or any other suitable ways.

At block 2404, the first SMF may send a PDU session SM context status notify comprising resource status set as released and a cause of release due to reactivation to the AMF.

At block 2406, the first SMF may receive a PDU session create SM context request from the AMF.

At block 2408, the first SMF may send a PDU session create request to a reselected SMF for replacing the second SMF.

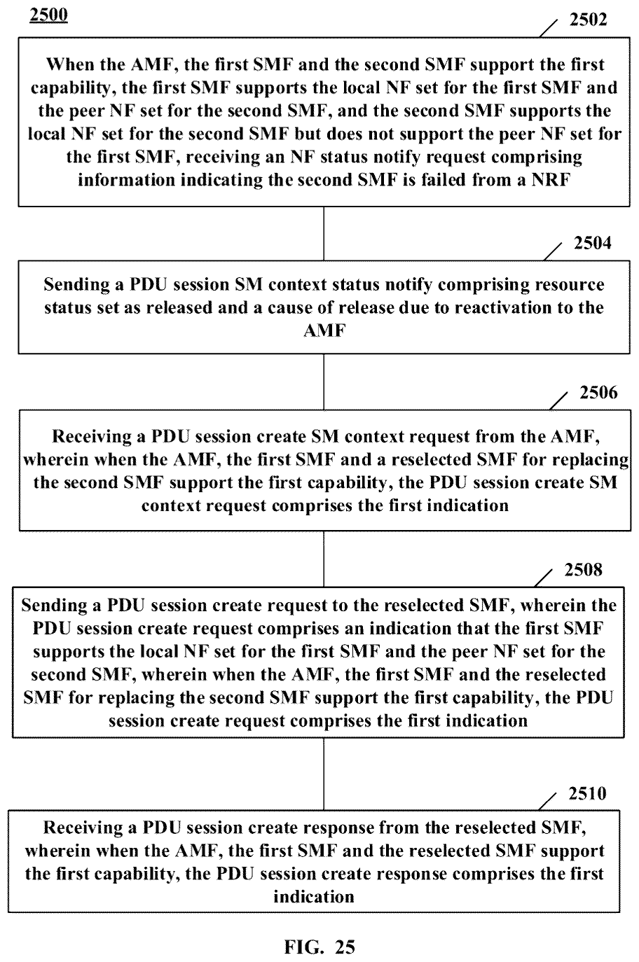

FIG. 25 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2500 as well as means or modules for accomplishing other processes in conjunction with other components. For some parts which have been described in the above embodiments, the description thereof is omitted here for brevity.

In an embodiment, the AMF, the first SMF and the second SMF support the first capability. The first SMF supports the local NF set for the first SMF and the peer NF set for the second SMF. The second SMF supports the local NF set for the second SMF but does not support the peer NF set for the first SMF.

At block 2502, the first SMF may receive an NF status notify request comprising information indicating the second SMF is failed from a NRF;

At block 2504, the first SMF may send a PDU session SM context status notify comprising resource status set as released and a cause of release due to reactivation to the AMF;

At block 2506, the first SMF may receive a PDU session create SM context request from the AMF. When the AMF, the first SMF and a reselected SMF for replacing the second SMF support the first capability, the PDU session create SM context request comprises the first indication.

At block 2508, the first SMF may send a PDU session create request to the reselected SMF. The PDU session create request comprises an indication that the first SMF supports the local NF set for the first SMF and the peer NF set for the second SMF. When the AMF, the first

SMF and the reselected SMF for replacing the second SMF support the first capability, the PDU session create request comprises the first indication.

At block 2510, the first SMF may receive a PDU session create response from the reselected SMF. When the AMF, the first SMF and the reselected SMF support the first capability, the PDU session create response may comprise the first indication.

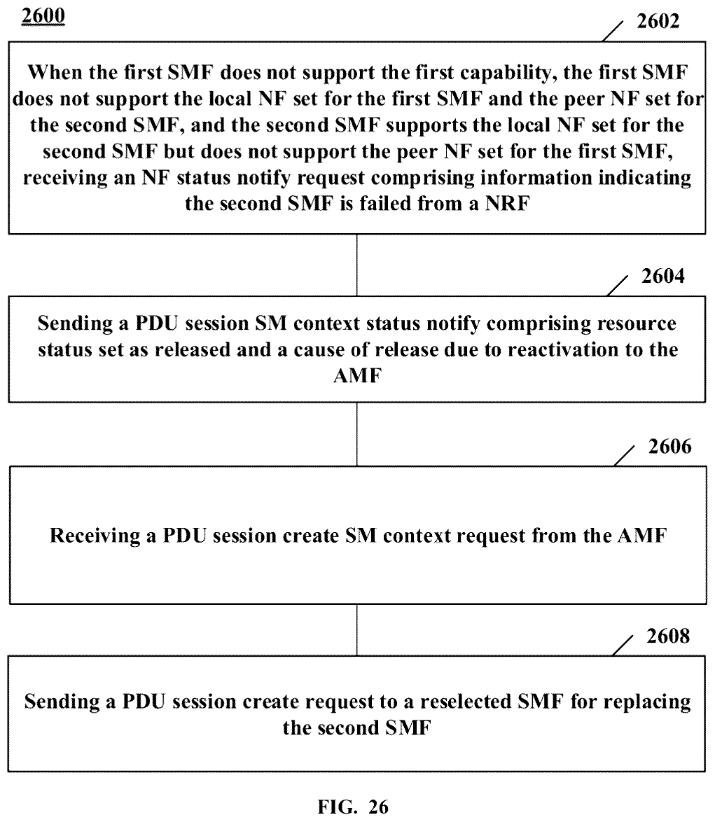

FIG. 26 shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 2600 as well as means or modules for accomplishing other processes in conjunction with other components. For some parts which have been described in the above embodiments, the description thereof is omitted here for brevity.

In an embodiment, the first SMF does not support the first capability. The first SMF does not support the local NF set for the first SMF and the peer NF set for the second SMF. The second SMF supports the local NF set for the second SMF but does not support the peer NF set for the first SMF.

At block 2602, the first SMF may receive an NF status notify request comprising information indicating the second SMF is failed from a NRF.

At block 2604, the first SMF may send a PDU session SM context status notify comprising resource status set as released and a cause of release due to reactivation to the AMF.

At block 2606, the first SMF may receive a PDU session create SM context request from the AMF.

At block 2608, the first SMF may send a PDU session create request to a reselected SMF for replacing the second SMF.

In an embodiment, the first SMF is a visited SMF and the second SMF is a home SMF or the first SMF is an intermediate SMF and the second SMF is an anchor SMF.

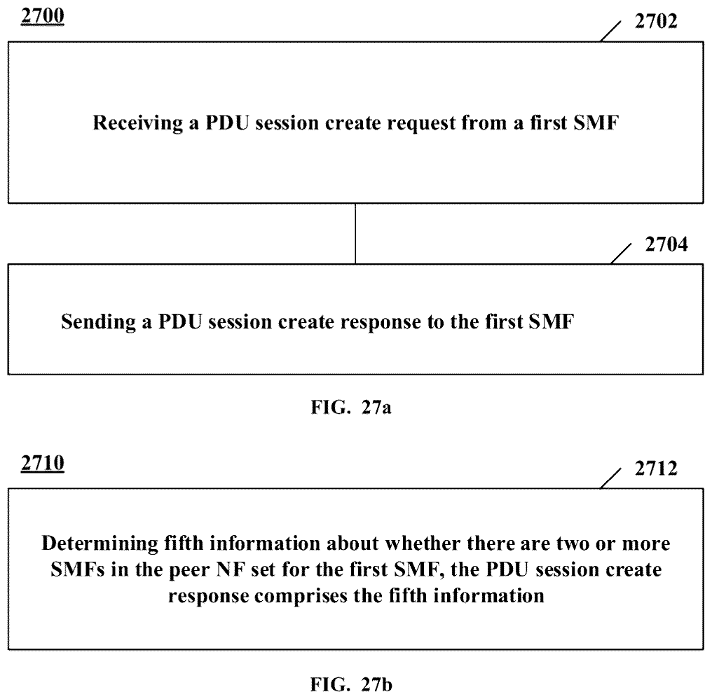

FIG. 27a shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 2700 as well as means or modules for accomplishing other processes in conjunction with other components. For some parts which have been described in the above embodiments, the description thereof is omitted here for brevity.

At block 2702, the second SMF may receive a PDU session create request from a first SMF.

At block 2704, the second SMF may send a PDU session create response to the first SMF.

In an embodiment, when the AMF, the first SMF and the second SMF support a first capability of PDU session restoration in case a failure of the first SMF, the PDU session create request comprises a first indication of supporting the first capability.

In an embodiment, when the first SMF supports a local NF set for the first SMF and a peer NF set for the second SMF, the PDU session create request further comprises an indication that the first SMF supports the local NF set for the first SMF and the peer NF set for the second SMF.

In an embodiment, when the AMF, the first SMF and the second SMF support the first capability, the PDU session create response comprises the first indication.

In an embodiment, when the first SMF supports the local NF set for the first SMF and the peer NF set for the second SMF and the second SMF supports a local NF set for the second SMF and a peer NF set for the first SMF, the PDU session create response comprises an indication that the second SMF supports the local NF set for the second SMF and the peer NF set for the first SMF.

In an embodiment, when the second SMF supports a peer NF set for the first SMF, the PDU session create response comprises an indication that the second SMF supports the peer NF set for the first SMF.

In an embodiment, the PDU session create request comprises third information about whether a first SMF supports a peer NF set for a second SMF and/or fourth information about whether the second SMF supports a peer NF set for the first SMF.

In an embodiment, the PDU session create request comprises fifth information about whether there are two or more SMFs in the peer NF set for the first SMF and/or sixth information about whether there are two or more SMFs in the peer NF set for the second SMF.

In an embodiment, the third information and the sixth information are represented by a single parameter and the fourth information and the fifth information are represented by a single parameter.

FIG. 27b shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 2710 as well as means or modules for accomplishing other processes in conjunction with other components. For some parts which have been described in the above embodiments, the description thereof is omitted here for brevity.

At block 2712, the second SMF may determine fifth information about whether there are two or more SMFs in the peer NF set for the first SMF. The PDU session create response comprises the fifth information.

In an embodiment, the PDU session create request comprises sixth information about whether there are two or more SMFs in the peer NF set for the second SMF.

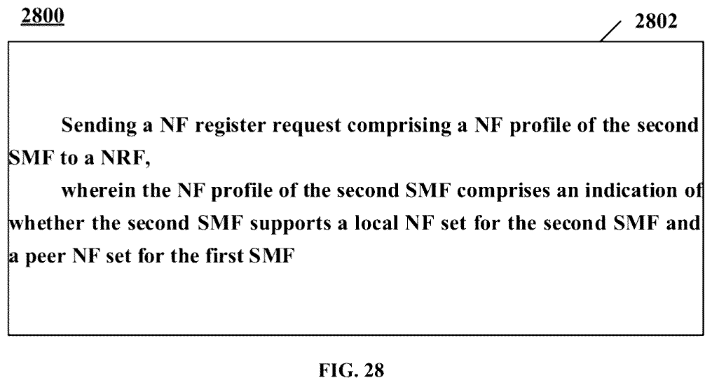

FIG. 28 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 2800 as well as means or modules for accomplishing other processes in conjunction with other components. For some parts which have been described in the above embodiments, the description thereof is omitted here for brevity.

At block 2802, the second SMF may send a NF register request comprising a NF profile of the second SMF to a NRF.

In an embodiment, the NF profile of the second SMF comprises an indication of whether the second SMF supports a capability of PDU session restoration in case a failure of a first SMF.

In an embodiment, the NF profile of the second SMF comprises an indication of whether the second SMF supports a local NF set for the second SMF and a peer NF set for the first SMF.

In an embodiment, the NF profile of the second SMF comprises an indication of whether the second SMF supports a peer NF set for the first SMF (e.g., hSMF roaming resilience indication).

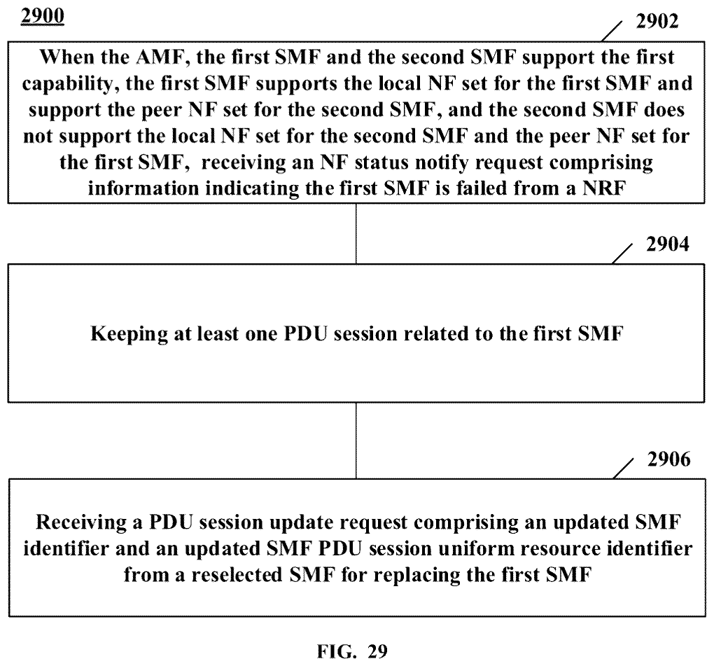

FIG. 29 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 2900 as well as means or modules for accomplishing other processes in conjunction with other components. For some parts which have been described in the above embodiments, the description thereof is omitted here for brevity.

In an embodiment, the AMF, the first SMF and the second SMF support the first capability, the first SMF supports the local NF set for the first SMF and support the peer NF set for the second SMF, and the second SMF does not support the local NF set for the second SMF and the peer NF set for the first SMF, the method further comprises:

At block 2902, the second SMF may receive an NF status notify request comprising information indicating the first SMF is failed from a NRF.

At block 2904, the second SMF may keep at least one PDU session related to the first SMF.

At block 2906, the second SMF may receive a PDU session update request comprising an updated SMF identifier and an updated SMF PDU session uniform resource identifier from a reselected SMF for replacing the first SMF.

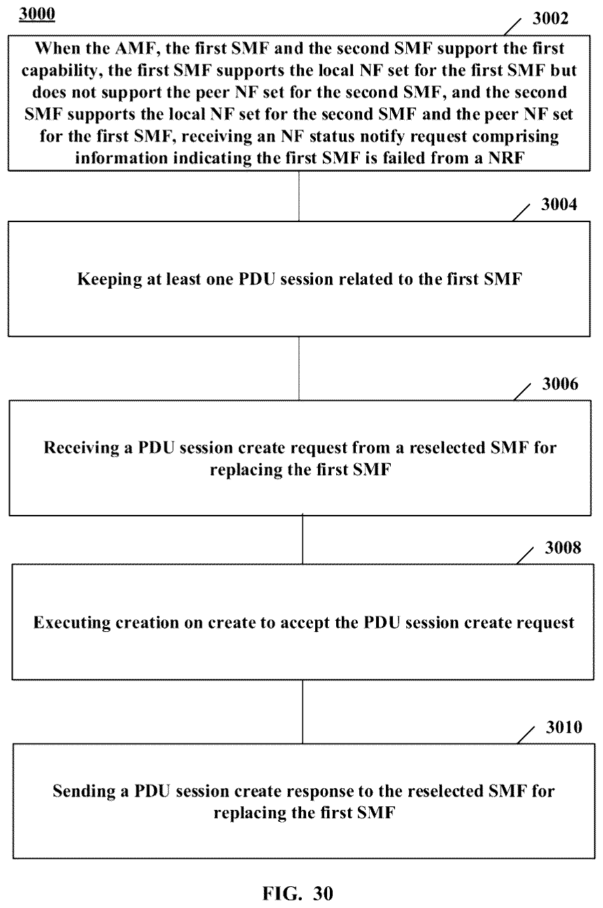

FIG. 30 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 3000 as well as means or modules for accomplishing other processes in conjunction with other components. For some parts which have been described in the above embodiments, the description thereof is omitted here for brevity.

In an embodiment, the AMF, the first SMF and the second SMF support the first capability, the first SMF supports the local NF set for the first SMF but does not support the peer NF set for the second SMF, and the second SMF supports the local NF set for the second SMF and the peer NF set for the first SMF.

At block 3002, the second SMF may receive an NF status notify request comprising information indicating the first SMF is failed from a NRF.

At block 3004, the second SMF may keep at least one PDU session related to the first SMF.

At block 3006, the second SMF may receive a PDU session create request from a reselected SMF for replacing the first SMF.

In an embodiment, when the AMF, the reselected SMF for replacing the first SMF and the second SMF support the first capability, the PDU session create SM context request comprises the first indication.

At block 3008, the second SMF may execute creation on create to accept the PDU session create request; and

At block 3010, the second SMF may send a PDU session create response to the reselected SMF for replacing the first SMF.

In an embodiment, when the AMF, the SMF for replacing the first SMF and the second SMF support the first capability, the PDU session create response comprises the first indication.

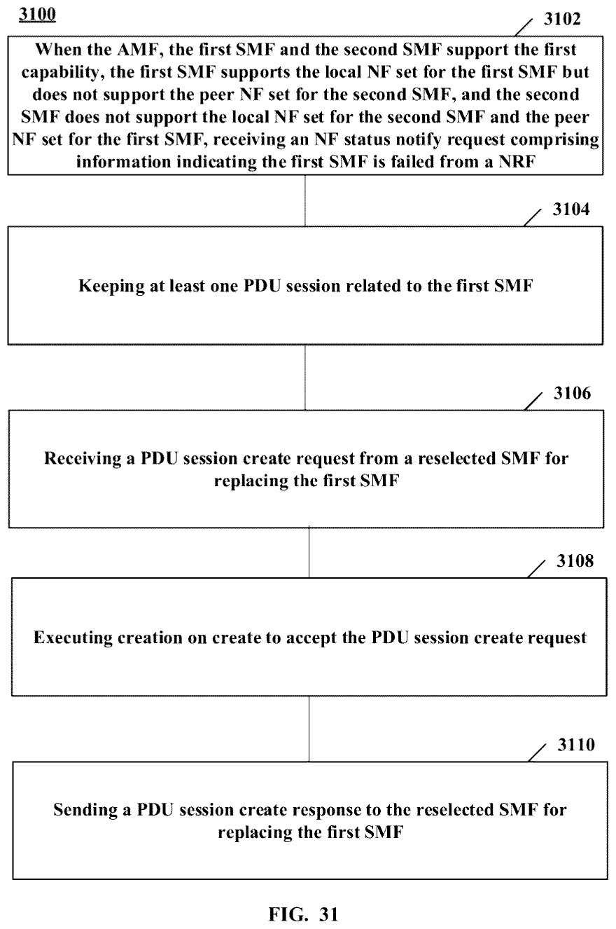

FIG. 31 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 3100 as well as means or modules for accomplishing other processes in conjunction with other components. For some parts which have been described in the above embodiments, the description thereof is omitted here for brevity.

In an embodiment, the AMF, the first SMF and the second SMF support the first capability, the first SMF supports the local NF set for the first SMF but does not support the peer NF set for the second SMF, and the second SMF does not support the local NF set for the second SMF and the peer NF set for the first SMF.

At block 3102, the second SMF may receive an NF status notify request comprising information indicating the first SMF is failed from a NRF.

At block 3104, the second SMF may keep at least one PDU session related to the first SMF.

At block 3106, the second SMF may receive a PDU session create request from a reselected SMF for replacing the first SMF.

In an embodiment, when the AMF, the reselected SMF for replacing the first SMF and the second SMF support the first capability, the PDU session create SM context request comprises the first indication;

At block 3108, the second SMF may execute creation on create to accept the PDU session create request.

At block 3110, the second SMF may send a PDU session create response to the reselected SMF for replacing the first SMF.

In an embodiment, when the AMF, the SMF for replacing the first SMF and the second SMF support the first capability, the PDU session create response comprises the first indication.

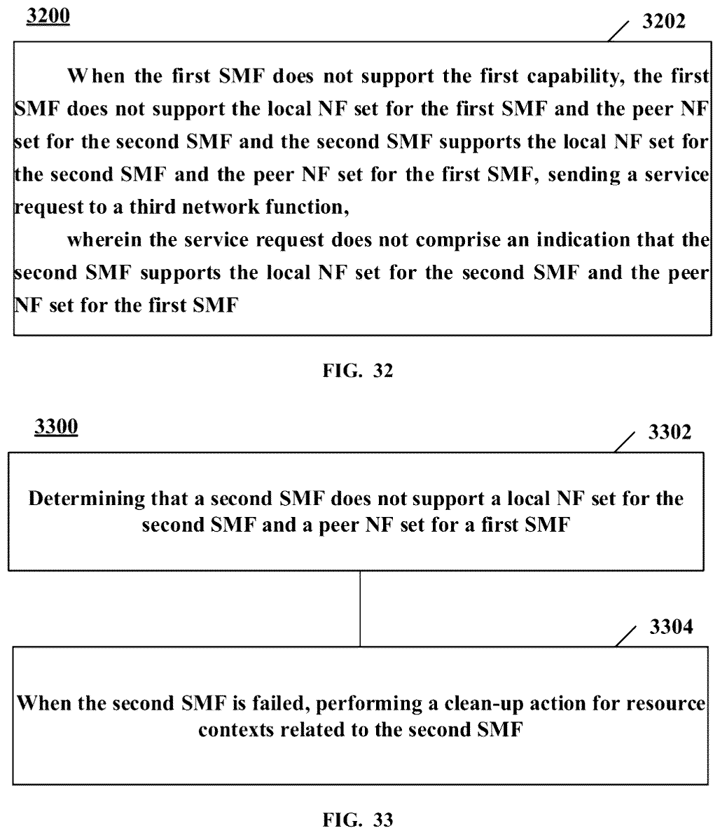

FIG. 32 shows a flowchart of a method according to another embodiment of the present disclosure, which may be performed by an apparatus implemented in or at or as a second SMF or communicatively coupled to the second SMF. As such, the apparatus may provide means or modules for accomplishing various parts of the method 3200 as well as means or modules for accomplishing other processes in conjunction with other components. For some parts which have been described in the above embodiments, the description thereof is omitted here for brevity.

In an embodiment, the first SMF does not support the first capability, the first SMF does not support the local NF set for the first SMF and the peer NF set for the second SMF and the second SMF supports the local NF set for the second SMF and the peer NF set for the first SMF.

At block 3202, the second SMF may send a service request to a third network function. The service request does not comprise an indication that the second SMF supports the local NF set for the second SMF and the peer NF set for the first SMF.

In an embodiment, the third network function comprises at least one of a policy control function (PCF), a user plane function (UPF), a Unified Data Management (UDM).

In an embodiment, the first SMF is a visited SMF and the second SMF is a home SMF. In an embodiment, the first SMF is an intermediate SMF and the second SMF is an anchor SMF.

FIG. 33 shows a flowchart of a method according to another embodiment of the present disclosure, which may be performed by an apparatus implemented in or at or as a third network function or communicatively coupled to the third network function. As such, the apparatus may provide means or modules for accomplishing various parts of the method 3300 as well as means or modules for accomplishing other processes in conjunction with other components. For some parts which have been described in the above embodiments, the description thereof is omitted here for brevity.

At block 3302, the third network function may determine that a second SMF does not support a local NF set for the second SMF and a peer NF set for a first SMF.

At block 3304, when the second SMF is failed, the third network function may perform a clean-up action for resource contexts related to the second SMF.

In an embodiment, third network function may determine that a second SMF does not support a local NF set for the second SMF and a peer NF set for a first SMF by sending a NF discovery request to a NRF and receiving a NF discovery response from the NRF. The NF discovery response comprises information indicating that the second SMF does not support a local NF set for the second SMF and a peer NF set for a first SMF.

In an embodiment, third network function may determine that a second SMF does not support a local NF set for the second SMF and a peer NF set for a first SMF by receive a service request from the second SMF. The service request does not comprise an indication that the second SMF supports the local NF set for the second SMF and the peer NF set for the first SMF.

In an embodiment, the third network function comprises at least one of a policy control function (PCF), a user plane function (UPF), a Unified Data Management (UDM).

In an embodiment, the first SMF is a visited SMF and the second SMF is a home SMF or the first SMF is an intermediate SMF and the second SMF is an anchor SMF.

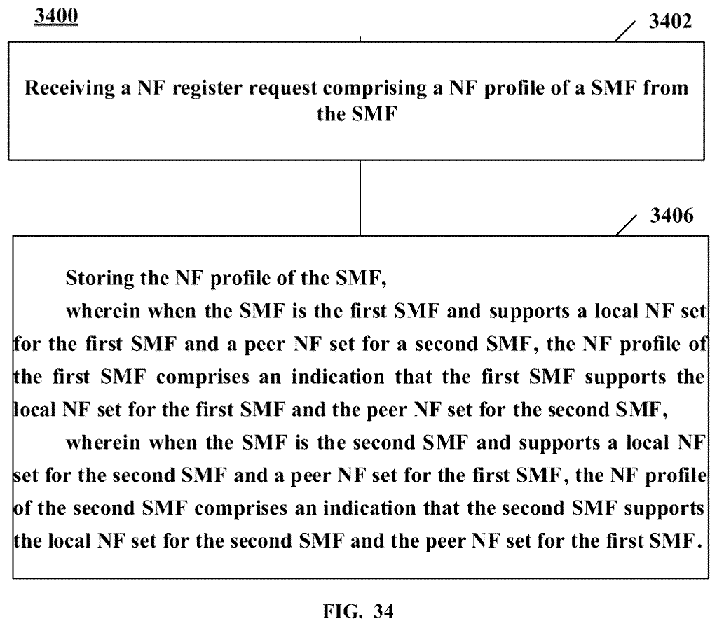

FIG. 34 shows a flowchart of a method according to another embodiment of the present disclosure, which may be performed by an apparatus implemented in or at or as a NRF or communicatively coupled to the NRF. As such, the apparatus may provide means or modules for accomplishing various parts of the method 3400 as well as means or modules for accomplishing other processes in conjunction with other components. For some parts which have been described in the above embodiments, the description thereof is omitted here for brevity.

At block 3402, the NRF may receive a NF register request comprising a NF profile of a SMF from the SMF.

At block 3404, the NRF may store the NF profile of the SMF.

In an embodiment, when the SMF is a first SMF and supports a first capability of PDU session restoration in case a failure of the first SMF, the NF profile of the first SMF comprises a first indication of supporting the first capability.

In an embodiment, when the SMF is the first SMF and supports a local NF set for the first SMF and a peer NF set for a second SMF, the NF profile of the first SMF comprises an indication that the first SMF supports the local NF set for the first SMF and the peer NF set for the second SMF,

In an embodiment, when the SMF is the second SMF and supports the first capability, the NF profile of the second SMF comprises the first indication,

In an embodiment, when the SMF is the second SMF and supports a local NF set for the second SMF and a peer NF set for the first SMF, the NF profile of the second SMF comprises an indication that the second SMF supports the local NF set for the second SMF and the peer NF set for the first SMF.

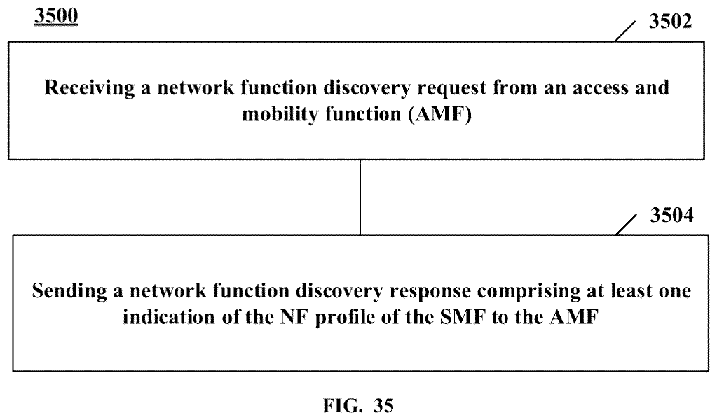

FIG. 35 shows a flowchart of a method according to another embodiment of the present disclosure, which may be performed by an apparatus implemented in or at or as a NRF or communicatively coupled to the NRF. As such, the apparatus may provide means or modules for accomplishing various parts of the method 3500 as well as means or modules for accomplishing other processes in conjunction with other components. For some parts which have been described in the above embodiments, the description thereof is omitted here for brevity.

At block 3502, the NRF may receive a network function discovery request from an access and mobility function (AMF).

At block 3504, the NRF may send a network function discovery response comprising at least one indication of the NF profile of the SMF to the AMF.

In an embodiment, the first SMF is a visited SMF and the second SMF is a home SMF or the first SMF is an intermediate SMF and the second SMF is an anchor SMF.

The following descriptions focus on the solutions for V-SMF and H-SMF roaming interworking. But the same solution principle also applies to a scenario where the I-SMF and

Anchor-SMF have different resilience capabilities or configurations.

FIG. 36 shows a flowchart of a method according to another embodiment of the present disclosure. For some parts which have been described in the above embodiments, the description thereof is omitted here for brevity.

At step 3601. vSMF sends Nnrf_NFRegister request {vSMF roaming resilience indication, vSMF restoration indication} to vNRF.

At step 3602. hSMF sends Nnrf_NFRegister request {hSMF roaming resilience indication, vSMF restoration indication} to hNRF.

At step 3603. AMF sends a hSMF discovery request to hNRF.

At step 3604. AMF receives hSMF roaming resilience indication and vSMF restoration indication from hNRF.

At step 3605. AMF sends a vSMF discovery request to vNRF.

At step 3606. AMF receives vSMF roaming resilience indication and vSMF restoration indication from vNRF.

At step 3607. AMF sends Nsmf_PDUSession_CreateSMContext Request to vSMF1.

In an embodiment, the Nsmf_PDUSession_CreateSMContext Request comprises vSMF restoration indication. In another embodiment, the Nsmf_PDUSession_CreateSMContext Request comprises vSMF roaming resilience indication (which may be a Boolean) and/or hSMF roaming resilience indication (which may be a Boolean).

At step 3608. AMF receives Nsmf_PDUSession_CreateSMContext Response {vSMF roaming resilience indication, vSMF restoration indication} from vSMF1.

At step 3609. vSMF1 sends Nsmf_PDUSession_Create Request to hSMF1. In an embodiment, the Nsmf_PDUSession_Create Request comprises vSMF roaming resilience indication and vSMF restoration indication. In another embodiment, the Nsmf_PDUSession_Create Request comprises vSMF roaming resilience indication and/or hSMF roaming resilience indication.

At step 3610. vSMF1 receives Nsmf_PDUSession_Create Response from hSMF1. In an embodiment, the Nsmf_PDUSession_Create Response comprises hSMF roaming resilience indication.

In an embodiment, the new thing to be added is the indication that there are multiple vSMFs in the same vSMF Set and multiple hSMFs in the same hSMF Set. Soultion I: AMF discovers there are multiple vSMFs in the same vSMF Set and/or multiple hSMFs in the hSMF Set, such info is sent by AMF to vSMF, e.g., “vSMF set indication” and “hSMF set indication”. The vSMF relays the vSMF set indication towards hSMF. Soultion II: the vSMF and hSMF themselves can also detect such inforamtion, the vSMF and hSMF can discover the other members in the same Set based on proprietary implementation mechanism, then the vSMF and hSMF can exchange such inforamtion. Solution III: There is another possibility which is to extend the concept of “vSMF set indication” and “hSMF set indication” to also cover the meaning of “vSMF roaming resilience indication” and “hSMF roaming resilience indication”. Then it only needs to exchange vSMF set indication” and “hSMF set indication”. That actually makes sense and simple for implementation, because vSMF set indication anyway is based on vSMF resilience indication, the same applies to hSMF. This solution is actually to replace the parameter name resilience indication with set indication, and extend the concept that the “set indication” means supporting local set, peer set and also multiple members in the same set.

In an embodiment, V-SMF and H-SMF register their capabilities of supporting roaming resilience and vSMF restoration in NRF.

In an embodiment, AMF gets V-SMF and H-SMF capabilities of supporting roaming resilience and vSMF restoration through NRF discovery.

In an embodiment, if AMF detects both V-SMF and H-SMF support vSMF restoration and AMF also supports vSMF restoration, then AMF shall include the vSMF restoration indication in the Create Request towards V-SMF. Otherwise, AMF shall not include vSMF restoration.

In an embodiment, if V-SMF supports vSMF restoration, V-SMF shall include the vSMF restoration indication (if received from AMF) in the Create Request to H-SMF. Note that V-SMF support of vSMF restoration means the V-SMF can relay the vSMF restoration indication (received from AMF) towards H-SMF.

In an embodiment, if V-SMF supports SMF Set, V-SMF includes its roaming resilience indication in the Create Request to H-SMF. Otherwise, V-SMF shall not send the roaming resilience indication to H-SMF.

In an embodiment, if AMF detects V-SMF and/or H-SMF support SMF Set based resilience (i.e., roaming resilience indication) and AMF also supports vSMF failure reselection based on SMF set, then AMF shall include the vSMF resilience indication and/or hSMF resilience indication in the Create Request towards V-SMF. Otherwise, AMF shall not include vSMF resilience and/or hSMF resilience indication.

In an embodiment, if AMF detects V-SMF and/or H-SMF support SMF Set based resilience (i.e., roaming resilience indication), then AMF shall include the vSMF resilience indication and/or hSMF resilience indication in the Create Request towards V-SMF.

In an embodiment, if H-SMF supports SMF Set and V-SMF also includes roaming resilience indication in the Create Request, the H-SMF includes roaming resilience indication in the Create Response to the V-SMF. Otherwise, H-SMF shall not send the roaming resilience indication to V-SMF.

Solution for V-SMF Failure:
V-SMF supports SMF set function
   H-SMF supports SMF Set:
      follows the normal Set handling.
   H-SMF doesn't support SMF Set:
      if AMF, V-SMF and H-SMF supports vSMF restoration, then H-SMF shall keep the affected PDU sessions and wait for the restoration triggered by AMF reselecting another vSMF in the same V-SMF Set and executing PDU Session Update procedure. Applicable to V-SMF failure scenario 1.
      Otherwise, H-SMF deletes the affected PDU sessions and AMF requests UEs to reactivate the affected PDU sessions.
V-SMF doesn't support SMF Set function
   Regardless of if H-SMF support SMF Set or not
      if AMF, V-SMF and H-SMF supports vSMF restoration, then H-SMF shall keep the affected PDU sessions and wait for the restoration triggered by AMF reselecting another vSMF and executing PDU Session Create on Create procedure. Applicable to V-SMF failure scenario 2 and 3.
      Otherwise, H-SMF deletes the affected PDU sessions and AMF requests UEs to reactivate the affected PDU sessions.

Solution for H-SMF failure:
H-SMF supports SMF set function
   V-SMF supports SMF Set:
      follows normal Set handling
   V-SMF doesn't support SMF Set
      V-SMF releases the affected PDU sessions and AMF requests UEs to reactivate the affected PDU sessions. Applicable to H-SMF failure scenario 4.
H-SMF doesn't support SMF Set function
   Regardless of if V-SMF support SMF Set or not V-SMF releases the affected PDU sessions and AMF requests UEs to reactivate the affected PDU sessions. Applicable to H-SMF failure scenario 5 and 6

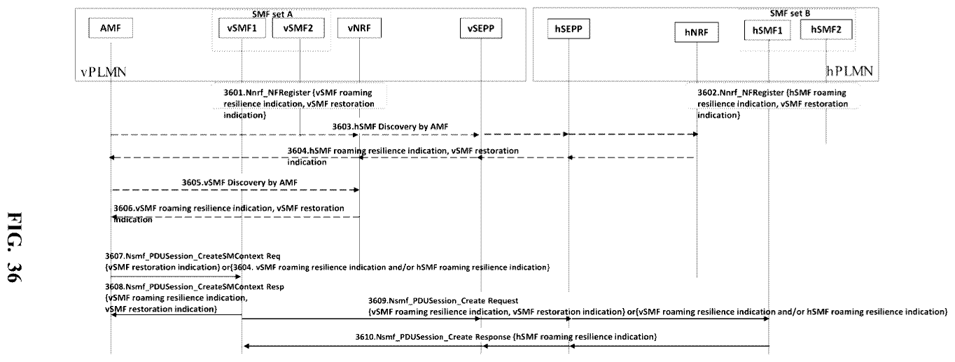

FIG. 37 shows a flowchart of an example solution for V-SMF failure according to an embodiment of the present disclosure. For some parts which have been described in the above embodiments, the description thereof is omitted here for brevity.

Scenario 1: VPLMN deploys SMF Set and V-SMF support SMF set, H-SMF doesn't support SMF Set

AMF includes vSMF restoration indication in the CreateSMContext request towards the selected V-SMF, and the V-SMF includes vSMF roaming resilience indication and vSMF restoration indication in PDUSessionCreateRequest towards the H-SMF.

When the selected V-SMF failure occurs, the H-SMF shall keep the associated PDU sessions and wait for restoration. The AMF triggers vSMF reselection for the established SM contexts in Update Request to trigger restoration, and the reselected V-SMF includes the updated vSMFId and vSmfPduSessionUri in the Update Request towards the original H-SMF.

At step 3701. AMF sends Nsmf_PDUSession_CreateSMContext request to vSMF1 and receives response from vSMF1.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF supports roaming resilience) and/or hSMF roaming resilience indication (i.e., hSMF does not support roaming resilience).

At step 3702. vSMF1 sends Nsmf_PDUSession_Create Request to hSMF1.

In an embodiment, the Nsmf_PDUSession_Create Request comprises vSMF roaming resilience indication and vSMF restoration indication. In another embodiment, the Nsmf_PDUSession_Create Request comprises vSMF roaming resilience indication and/or hSMF roaming resilience indication received from AMF.

At step 3703. vSMF1 receives Nsmf_PDUSession_Create Response from hSMF1. In an embodiment, the Nsmf_PDUSession_Create Response comprises vSMF restoration indication (i.e., hSMF supports PDU session restoration in case of vSMF failure).

At step 3704. vNRF (visited NRF) sends Nnrf_NFManagement_NFStatusNotify request (“vSMF1 SUSPENDED”) to hSMF1.

At step 3705. hSMF1 keeps the PDU sessions related to the failed vSMF and wait for restoration

At step 3706. vNRF sends Nnrf_NFManagement_NFStatusNotify request (“vSMF1 SUSPENDED”) to AMF.

At step 3708. AMF triggers vSMF reselection for established SM sessions.

At step 3709. AMF sends Nsmf_PDUSession_UpdateSMContext Request {SmConextUpdateData} to vSMF2.

At step 3710. vSMF2 sends Nsmf_PDUSession_Update Request {vsmfId=vSMF2Id, vsmfPduSessionUri=vSMF2} to hSMF1.

At step 3711. hSMF1 sends Nsmf_PDUSession_Update Response to vSMF2.

At step 3712. vSMF2 sends Nsmf_PDUSession_UpdateSMContext Response {SmConextUpdatedData} to AMF.

Some messages as shown in FIG. 37 may be same as the corresponding messages as described in 3GPP TS 23.502 V17.2.1. Some messages as shown in FIG. 37 may be enhanced according to embodiments of the present disclosure.

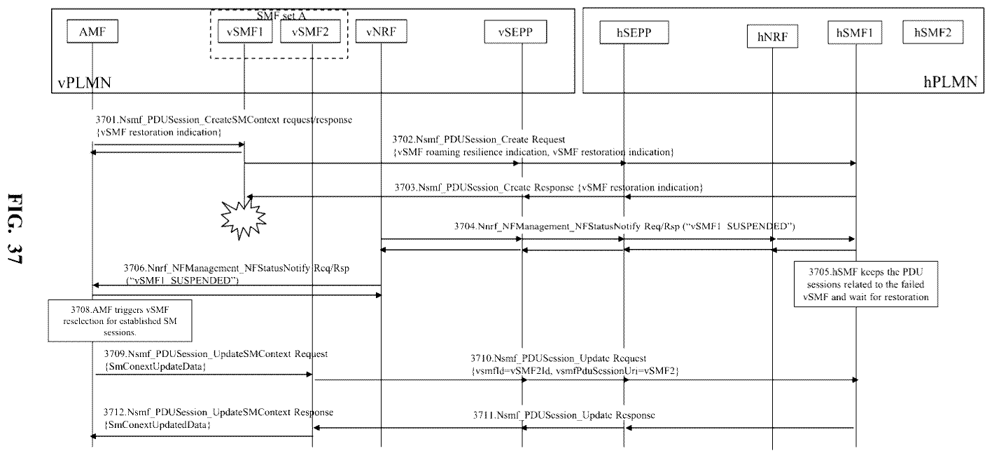

FIG. 38 shows a flowchart of an example solution for V-SMF failure according to another embodiment of the present disclosure. For some parts which have been described in the above embodiments, the description thereof is omitted here for brevity.

Scenario 2-VPLMN deploys SMF Sct but V-SMF doesn't support SMF Set, H-SMF supports SMF Set

AMF includes vSMF restoration indication in the CreateSMContext request towards the selected vSMF. The V-SMF relays the received vSMF restoration indication in

PDUSessionCreateRequest towards the H-SMF, but the V-SMF doesn't include vSMF roaming resilience indication and as the vSMF doesn't support SMF Set.

When the selected V-SMF failure occurs, the H-SMF shall keep the associated PDU sessions and wait for vSMF restoration. The AMF triggers PDU session reactivation to restore the impacted PDU sessions, and the reselected V-SMF sends PDUSessionCreateRequest towards the original H-SMF. The H-SMF executes Create on Create to accept the new PDU Session Request.

At step 3801. AMF sends Nsmf_PDUSession_CreateSMContext request to vSMF1 and receives response from vSMF1.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF does not support roaming resilience) and/or hSMF roaming resilience indication (i.e., hSMF supports roaming resilience).

At step 3802. vSMF1 sends Nsmf_PDUSession_Create Request to hSMF1.

In an embodiment, the Nsmf_PDUSession_Create Request comprises vSMF restoration indication. In another embodiment, the Nsmf_PDUSession_Create Request comprises vSMF roaming resilience indication and/or hSMF roaming resilience indication received from AMF.

At step 3803. hSMF1 sends Nsmf_PDUSession_Create Response to vSMF1. In an embodiment, the Nsmf_PDUSession_Create Response comprises vSMF restoration indication (i.e., hSMF supports PDU session restoration in case of vSMF failure).

At step 3804. vNRF sends Nnrf_NFManagement_NFStatusNotify request (“vSMF1 SUSPENDED”) to hSMF1 and receives response from hSMF1.

At step 3805. hSMF1 keeps the PDU sessions related to the failed vSMF.

At step 3806. vNRF sends Nnrf_NFManagement_NFStatusNotify request (“vSMF1 SUSPENDED”) to AMF and receives response from AMF.

At step 3807. AMF triggers PDU session reactivation.

At step 3808. AMF sends Nsmf_PDUSession_CreateSMContext request to vSMF2 and receives response from vSMF2.

In an embodiment, the Nsmf_PDUSession_CreateSMContext Request comprises

VSMF restoration indication (i.e., vSMF2 supports PDU session restoration in case of vSMF2 failure). In another embodiment, the Nsmf_PDUSession_CreateSMContext Request comprises vSMF roaming resilience indication (i.e., vSMF does not support roaming resilience) and/or hSMF roaming resilience indication (i.e., hSMF supports roaming resilience).

At step 3809. vSMF2 sends Nsmf_PDUSession_Create Request {vSMF restoration indication} to hSMF1.

In an embodiment, the Nsmf_PDUSession_Create Request comprises vSMF restoration indication. In another embodiment, the Nsmf_PDUSession_Create Request comprises vSMF roaming resilience indication and/or hSMF roaming resilience indication received from AMF.

At step 3810. hSMF1 executes creation on create.

At step 3811. hSMF1 sends Nsmf_PDUSession_Create Response to vSMF2.

In an embodiment, the Nsmf_PDUSession_Create Response comprises vSMF restoration indication (i.e., hSMF supports PDU session restoration in case of vSMF failure).

Some messages as shown in FIG. 38 may be same as the corresponding messages as described in 3GPP TS 23.502 V17.2.1. Some messages as shown in FIG. 38 may be enhanced according to embodiments of the present disclosure.

FIG. 39 shows a flowchart of an example solution for V-SMF failure according to another embodiment of the present disclosure. For some parts which have been described in the above embodiments, the description thereof is omitted here for brevity.

Scenario 3-VPLMN deploys SMF Sct but V-SMF doesn't support SMF Set, H-SMF doesn't support SMF Set

As illustrated below, the same restoration solution as Scenario 2 applies. That is, after the selected V-SMF failure occurs, the H-SMF shall keep the associated PDU sessions and wait for restoration. The AMF triggers PDU session reactivation to restore the impacted PDU sessions, and the reselected V-SMF sends PDU Session CreateRequest towards the original H-SMF. The H-SMF executes Create on Create to accept the new PDU Session Request.

At step 3901. AMF sends Nsmf_PDUSession_CreateSMContext request to vSMF1 and receives response from vSMF1.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF does not support roaming resilience) and/or hSMF roaming resilience indication (i.e., hSMF does not support roaming resilience).

At step 3902. vSMF1 sends Nsmf_PDUSession_Create Request to hSMF1.

In an embodiment, the Nsmf_PDUSession_Create Request comprises vSMF restoration indication. In another embodiment, the Nsmf_PDUSession_Create Request comprises vSMF roaming resilience indication and/or hSMF roaming resilience indication received from AMF.

At step 3903. hSMF1 sends Nsmf_PDUSession_Create Response to vSMF1. In an embodiment, the Nsmf_PDUSession_Create Response comprises vSMF restoration indication (i.e., hSMF supports PDU session restoration in case of vSMF failure).

At step 3904. vNRF (visited NRF) sends Nnrf_NFManagement_NFStatusNotify request (“vSMF1 SUSPENDED”) to hSMF1 and receives response from hSMF1.

At step 3905. hSMF1 keeps the PDU sessions related to the failed vSMF1.

At step 3906. vNRF sends Nnrf_NFManagement_NFStatusNotify request (“vSMF1 SUSPENDED”) to AMF.

At step 3907. AMF triggers PDU session reactivation.

At step 3908. AMF sends Nsmf_PDUSession_CreateSMContext request to vSMF2 and receives response from vSMF2.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF does not support roaming resilience) and/or hSMF roaming resilience indication (i.e., hSMF does not support roaming resilience).

At step 3909. vSMF2 sends Nsmf_PDUSession_Create Request hMSF1.

In an embodiment, the Nsmf_PDUSession_Create Request comprises vSMF restoration indication. In another embodiment, the Nsmf_PDUSession_Create Request comprises vSMF roaming resilience indication and/or hSMF roaming resilience indication received from AMF.

At step 3910. hSMF1 executes creation on create.

At step 3911. hSMF1 sends Nsmf_PDUSession_Create Response to vSMF2. In an embodiment, the Nsmf_PDUSession_Create Response comprises vSMF restoration indication (i.e., hSMF2 supports PDU session restoration in case of vSMF failure).

Some messages as shown in FIG. 39 may be same as the corresponding messages as described in 3GPP TS 23.502 V17.2.1. Some messages as shown in FIG. 39 may be enhanced according to embodiments of the present disclosure.

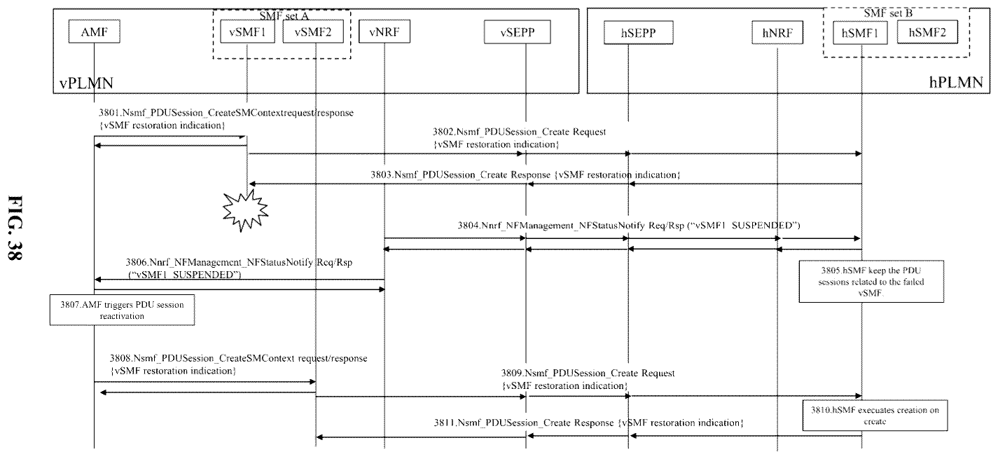

FIG. 40 shows a flowchart of an example solution for H-SMF failure according to an embodiment of the present disclosure. For some parts which have been described in the above embodiments, the description thereof is omitted here for brevity.

Scenario 4—HPLMN deploys SMF Set and H-SMF supports SMF Set, V-SMF doesn't support SMF Set

The AMF doesn't include vSMF restoration indication to the V-SMF if the selected V-SMF doesn't support vSMF restoration. The V-SMF doesn't includes vSMF roaming resilience indication and vSMF restoration indication in PDUSessionCreateRequest towards the selected H-SMF. The H-SMF doesn't return roaming resilience indication in the response to the V-SMF as the H-SMF detects the V-SMF doesn't support roaming resilience. The H-SMF shall also suppress the roaming resilience indication in the service request towards the surrounding 5GC NFs in HPLMN.

When the original H-SMF failure occurs, the surrounding 5GC NFs in HPLMN shall clean-up the contexts associated with the failed H-SMF as the H-SMF doesn't include the hSMF roaming resilience indication in service request (or through NRF discovery). The associated V-SMF shall initiate SM Context Release towards the AMF, and the AMF triggers PDU session reactivation for the affected PDU sessions.

The vSMF restoration indication is not used in H-SMF failure scenario.

At step 4001. H-SMF shall suppress roaming resilience indication in the requests to the other 5GC NFs in HPLMN if V-SMF doesn't support hSMF roaming resilience.

At step 4002. AMF sends Nsmf_PDUSession_CreateSMContext request to vSMF1 and receives Nsmf_PDUSession_CreateSMContext response from vSMF1.

In an embodiment, the Nsmf_PDUSession_CreateSMContext Request comprises vSMF roaming resilience indication (i.e., vSMF does not support roaming resilience) and/or hSMF roaming resilience indication (i.e., hSMF supports roaming resilience).

At step 4003. vSMF1 sends Nsmf_PDUSession_Create Request to hSMF1.

In another embodiment, the Nsmf_PDUSession_Create Request comprises vSMF roaming resilience indication and or hSMF roaming resilience indication received from AMF.

At step 4004. hSMF1 sends Npcf_SMPolicyControl_Create request to PCF1 and receives Npcf_SMPolicyControl_Create response from PCF1.

At step 4005. hSMF1 sends Nsmf_PDUSession_Create Response to vSMF1.

At step 4006. hNRF sends Nnrf_NFManagement_NFStatusNotify request (“hSMF1 SUSPENDED”) to vSMF1 and receives Nnrf_NFManagement_NFStatusNotify response from vSMF1.

At step 4007. PCF clean-up the contexts related to the failed hSMF based on the capability indication in the initial service request

At 4008. step vSMF1sends Nsmf_PDUSession_SMContextStatusNotify {resourceStatus=RELEASED, cause= “REL_DUE_TO_REACTIVATION”} to AMF and receives response from AMF.

At step 4009. AMF sends Nsmf_PDUSession_CreateSMContext to vSMF1 and receives response from vSMF1.

In an embodiment, the Nsmf_PDUSession_CreateSMContext Request comprises vSMF roaming resilience indication (i.e., vSMF does not support roaming resilience) and/or hSMF roaming resilience indication (i.e., hSMF supports roaming resilience).

At step 4010. vSMF1 sends Nsmf_PDUSession_Create Request to hSMF2.

In another embodiment, the Nsmf_PDUSession_Create Request comprises vSMF roaming resilience indication and or hSMF roaming resilience indication received from AMF.

At step 4011. hSMF2 sends Npcf_SMPolicyControl_Create request to PCF1 and receives a response from PCF1.

At step 4012. hSMF2 sends Nsmf_PDUSession_Create Response to vSMF1

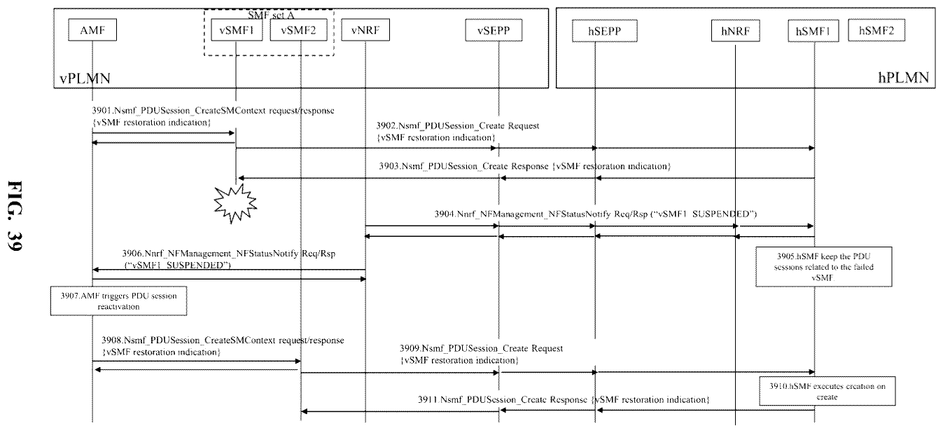

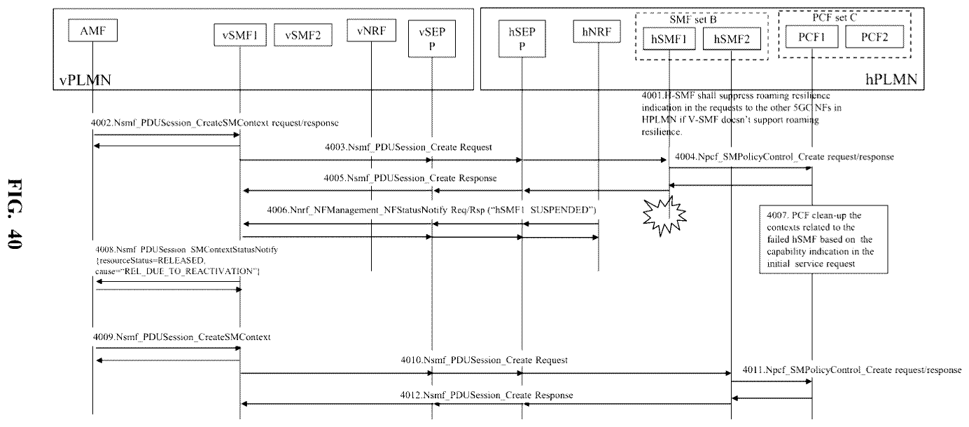

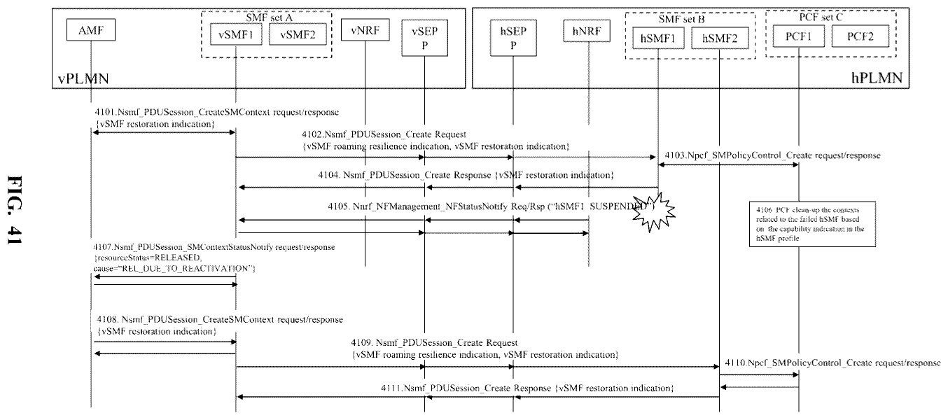

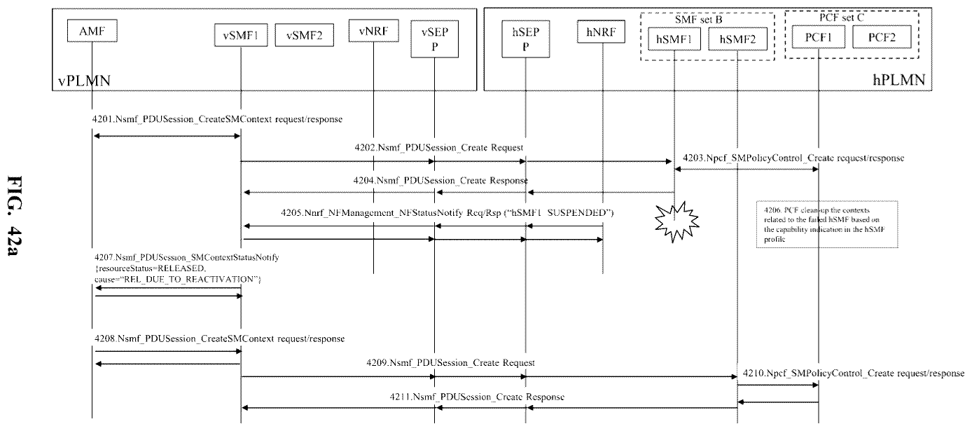

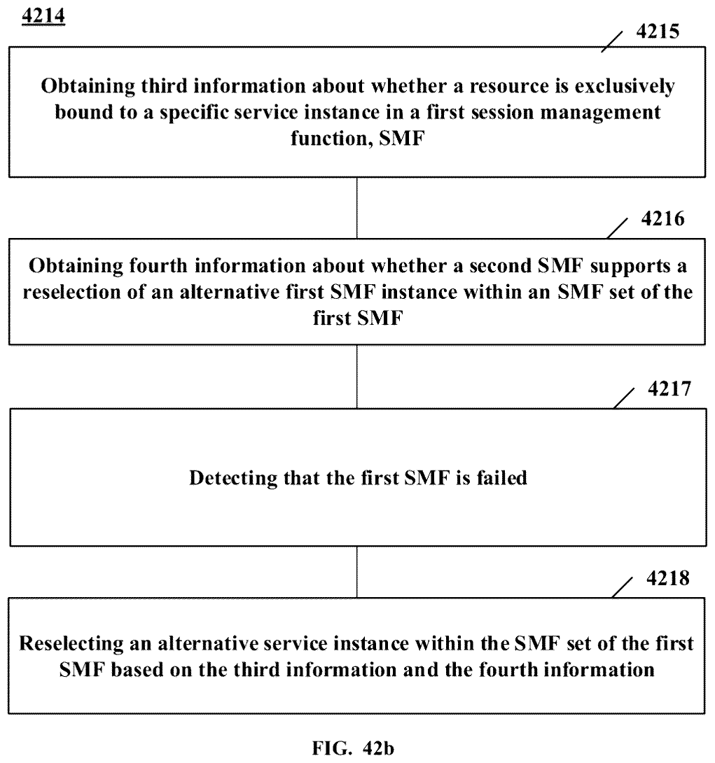

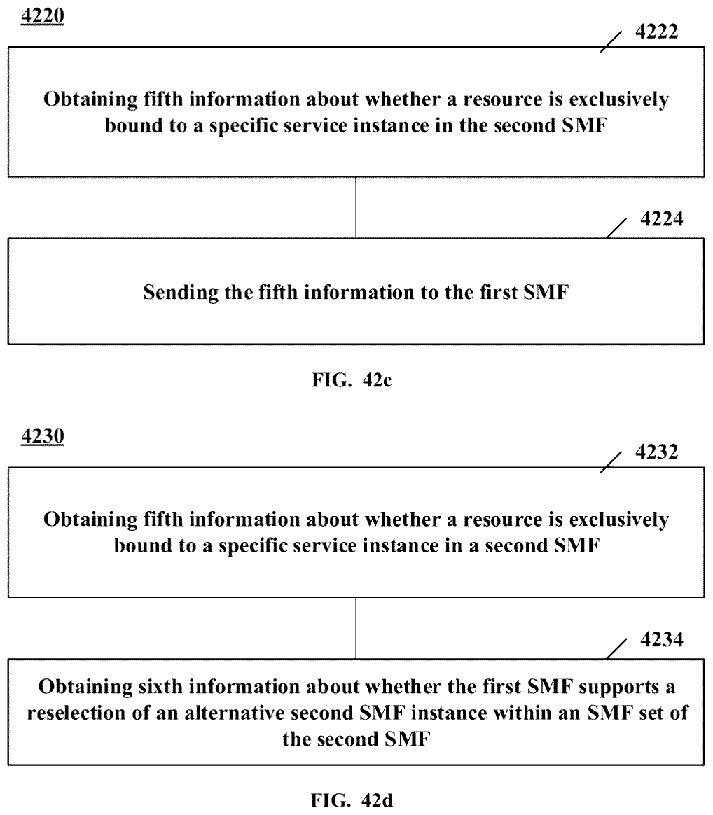

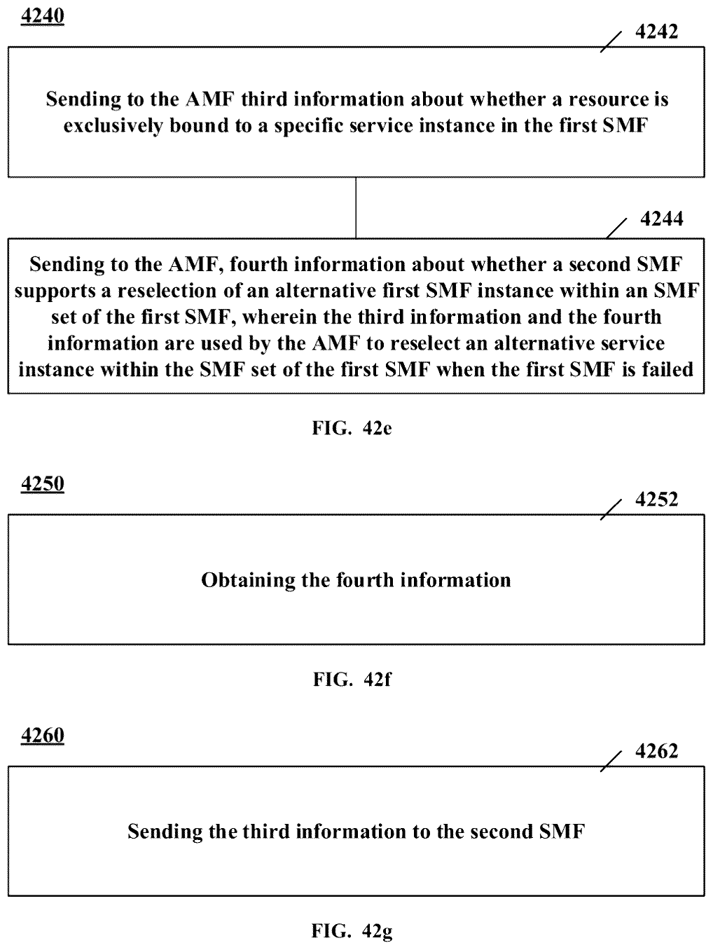

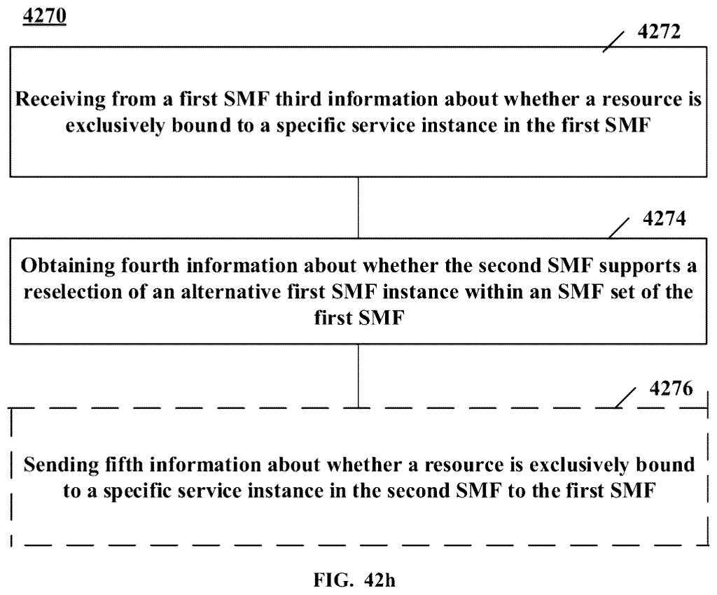

Some messages as shown in FIG. 41 may be same as the corresponding messages as described in 3GPP TS 23.502 V17.2.1. Some messages as shown in FIG. 42 may be enhanced according to embodiments of the present disclosure.

FIG. 41 shows a flowchart of an example solution for H-SMF failure according to another embodiment of the present disclosure. For some parts which have been described in the above embodiments, the description thereof is omitted here for brevity.

Scenario 5—HPLMN deploys SMF Set but HI-SMF doesn't support SMF Set, V-SMF supports SMF Set

AMF includes vSMF restoration indication in the CreateSMContext request to vSMF, and the V-SMF includes vSMF roaming resilience indication and vSMF restoration indication in PDUSessionCreateRequest towards the selected HI-SMF. HI-SMF doesn't include roaming resilience indication in the response to V-SMF as H-SMF doesn't support SMF Set.

When the original H-SMF failure occurs, the surrounding 5GC NFs in HPLMN shall clean-up the contexts associated with the failed H-SMF as the H-SMF doesn't include the hSMF roaming resilience indication in service request (or through NRF discovery). The associated V-SMF shall initiate SM Context Release towards the AMF, and the AMF triggers PDU session reactivation for the affected PDU sessions.

The vSMF restoration indication is not useful in hSMF failure scenario.

At step 4101. AMF sends Nsmf_PDUSession_CreateSMContext request to vSMF1 and receives response from vSMF1.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF supports roaming resilience) and/or hSMF roaming resilience indication (i.e., hSMF does not support roaming resilience).

At step 4102. vSMF1 sends Nsmf_PDUSession_Create Request to hSMF1.

In an embodiment, the Nsmf_PDUSession_Create Request comprises vSMF restoration indication an vSMF roaming resilience indication. In another embodiment, the Nsmf_PDUSession_Create Request comprises vSMF roaming resilience indication and/or hSMF roaming resilience indication received from AMF.

At step 4103. hSMF1 sends Npcf_SMPolicyControl_Create request to PCF1 and receives Npcf_SMPolicyControl_Create response from PCF1.

At step 4104. hSMF1 sends Nsmf_PDUSession_Create Response to vSMF1. In an embodiment, the Nsmf_PDUSession_Create Response comprises vSMF restoration indication (i.e., hSMF supports PDU session restoration in case of vSMF failure).

At step 4105. hNRF sends Nnrf_NFManagement_NFStatusNotify request (“hSMF1 SUSPENDED”) to vSMF1 and receives Nnrf_NFManagement_NFStatusNotify response from vSMF1.

At step 4106. PCF clean-up the contexts related to the failed hSMF based on the capability indication in the hSMF profile.

At step 4107. vSMF1 sends Nsmf_PDUSession_SMContextStatusNotify request {resourceStatus=RELEASED, cause= “REL_DUE_TO_REACTIVATION”} to AMF and receives Nsmf_PDUSession_SMContextStatusNotify response from AMF.

At step 4108. AMF sends Nsmf_PDUSession_CreateSMContext request to vSMF1 and receives response from vSMF1.

In an embodiment, the Nsmf_PDUSession_CreateSMContext Request comprises vSMF restoration indication (i.e., vSMF supports PDU session restoration in case of vSMF failure). In another embodiment, the Nsmf_PDUSession_CreateSMContext Request comprises vSMF roaming resilience indication (i.e., vSMF supports roaming resilience) and/or hSMF roaming resilience indication (i.e., hSMF2 does not support roaming resilience).

At step 4109. vSMF1 sends Nsmf_PDUSession_Create Request to hSMF2.

In an embodiment, the Nsmf_PDUSession_Create Request comprises vSMF restoration indication and vSMF roaming resilience indication. In another embodiment, the Nsmf_PDUSession_Create Request comprises vSMF roaming resilience indication and/or hSMF roaming resilience indication received from AMF.

At step 4110. hSMF2 sends Npcf_SMPolicyControl_Create request to PCF1 and receives Npcf_SMPolicyControl_Create response from PCF1

At step 4111. hSMF2 sends Nsmf_PDUSession_Create Response to vSMF1. In an embodiment, the Nsmf_PDUSession_Create Response comprises vSMF restoration indication (i.e., hSMF supports PDU session restoration in case of vSMF failure).

Some messages as shown in FIG. 41 may be same as the corresponding messages as described in 3GPP TS 23.502 V17.2.1. Some messages as shown in FIG. 42 may be enhanced according to embodiments of the present disclosure.

FIG. 42a shows a flowchart of an example solution for H-SMF failure according to another embodiment of the present disclosure. For some parts which have been described in the above embodiments, the description thereof is omitted here for brevity.

Scenario 6-HPLMN deploys SMF Set but H-SMF doesn't support SMF Set, V-SMF doesn't support SMF Sct

As illustrated below, the same restoration solution as Scenario 5 applies. That is, after the original H-SMF failure occurs, the surrounding 5GC NFs in HPLMN shall clean-up the contexts associated with the failed H-SMF as the H-SMF doesn't include the hSMF roaming resilience indication in service request (or through NRF discovery). The associated V-SMF shall initiate SM Context Release towards the AMF, and the AMF triggers PDU session reactivation for the affected PDU sessions.

At step 4201. AMF sends Nsmf_PDUSession_CreateSMContext request to vSMF1 and receives response from vSMF1.

In an embodiment, the Nsmf_PDUSession_CreateSMContext Request comprises vSMF roaming resilience indication (i.e., vSMF does not support roaming resilience) and/or hSMF roaming resilience indication (i.e., hSMF does not support roaming resilience).

At step 4202. vSMF1 sends Nsmf_PDUSession_Create Request to hSMF1.

In an embodiment, the Nsmf_PDUSession_Create Request comprises vSMF roaming resilience indication and/or hSMF roaming resilience indication received from AMF.

At step 4203. hSMF1 sends Npcf_SMPolicyControl_Create request to PCF1 and receives Npcf_SMPolicyControl_Create response from PCF1.

At step 4204. hSMF1 sends Nsmf_PDUSession_Create Response to vSMF1.

At step 4205. hNRF (home NRF) sends Nnrf_NFManagement_NFStatusNotify Request (“hSMF1 SUSPENDED”) to vSMF1 and receives Nnrf_NFManagement_NFStatusNotify Response from vSMF1.

At step 4206. PCF clean-up the contexts related to the failed hSMF based on the capability indication in the hSMF profile

At step 4207. vSMF1 sends Nsmf_PDUSession_SMContextStatusNotify request {resourceStatus=RELEASED, cause= “REL_DUE_TO_REACTIVATION”} to AMF and receives Nsmf_PDUSession_SMContextStatusNotify response from AMF.

At step 4208. AMF sends Nsmf_PDUSession_CreateSMContext request to vSMF1 and receives response from vSMF1.

In an embodiment, the Nsmf_PDUSession_CreateSMContext Request comprises vSMF roaming resilience indication (i.e., vSMF does not support roaming resilience) and/or hSMF roaming resilience indication (i.e., hSMF does not support roaming resilience).

At step 4209. vSMF1 sends Nsmf_PDUSession_Create Request to hSMF2.

In an embodiment, the Nsmf_PDUSession_Create Request comprises vSMF roaming resilience indication and/or hSMF roaming resilience indication received from AMF.

At step 4210. hSMF2 sends Npcf_SMPolicyControl_Create request to PCF1 and receives Npcf_SMPolicyControl_Create response from PCF1.

At step 4211. hSMF2 sends Nsmf_PDUSession_Create Response to vSMF1.

Some messages as shown in FIG. 42 may be same as the corresponding messages as described in 3GPP TS 23.502 V17.2.1. Some messages as shown in FIG. 42 may be enhanced according to embodiments of the present disclosure.

The following contents may be comprised in 3GPP TS 23.527 V17.3.1.

6.X Restoration Procedures for Home Routed PDU Session

6.X.1 General

This clause specifies requirements in the AMF, V-SMF and H-SMF for restoration procedures when the SMF Set feature is not supported either in VPLMN or in HPLMN.

The procedures specified in clause 6.5 shall be used to restore a Home Routed PDU Session by reselecting an alternative V-SMF or H-SMF when both the V-SMF and the H-SMF support SMF Set feature for the roaming interface. The V-SMF and HI-SMF may include a Binding Indication if supported (i.e. “3gpp-sbi-binding” HTTP header, see clause 5.2.3.2.6 of 3GPP TS 29.500 [10]) or set “NF Set for Roaming Interface (SETFRI)” feature bit in the SupportFeature attribute in the service request and response message respectively to indicate its support of SMF set feature as further described below.

When establishing or upon an inter AMF mobility procedure for a Home Routed PDU Session, the (target) AMF shall set the corresponding feature bit in the supportFeatures attribute in the service request messages towards the V-SMF if it supports “Restoration by V-SMF Reselection at V-SMF failure” (RVSMFR) feature.

The V-SMF shall set the corresponding feature bit in the supportFeatures attribute in the service request messages towards the H-SMF if both the AMF and the V-SMF supports “Restoration by V-SMF Reselection at V-SMF failure” (RVSMFR) feature. The V-SMF shall set the corresponding feature bit in the supportFeatures attribute in the service request messages towards the H-SMF and in the service response message towards the AMF if it supports SETFRI feature.

The H-SMF shall set the corresponding feature bits if it supports RVSMFR or SETFRI respectively in the supportedFeatures in the service response message towards the V-SMF.

6.X.2 V-SMF failure

When the H-SMF detects the failure of the V-SMF, it shall retrieve all PDU sessions associated with the failed V-SMF and perform the following procedure for those PDU sessions:
if the V-SMF supports SETFRI feature
   and if the H-SMF supports SETFRI feature, the H-SMF shall keep the PDU session and may reselect an alternative V-SMF, e.g. when it needs any request message to the V-SMF;
   and if the H-SMF does not support SETFRI feature but the H-SMF support the RVSMFR feature, the H-SMF shall keep the PDU session and wait for the restoration of the PDU session triggered by the AMF reselecting another V-SMF in the same set if V-SMF and the AMF support the RVSMFR feature; otherwise, the H-SMF may delete affected PDU sessions. The AMF may request UE to reactivate PDU session based on the local configuration if the PDU session is to be deleted;
if the V-SMF does not support SETFRI feature:
regardless of if the H-SMF supports SETFRI feature, the H-SMF may delete affected PDU sessions.

When the AMF detects the failure of V-SMF, it shall retrieve all PDU sessions associated with the failed V-SMF and perform the following procedure for those PDU sessions:
if the H-SMF and the AMF support the RVSMFR feature, the AMF shall reselect an alternative V-SMF pertaining to the same NF (service) Set as the failed V-SMF pertaining to if the V-SMF supports SETFRI feature.
NOTE: It is assumed if a SMF supports the SETFRI feature, it will support SMF set feature for non-roaming reference point(s).
otherwise, the AMF shall release the affected PDU session(s) and may request the UE(s) to reactivate the PDU session(s) based on the local configuration.

6.X.2 H-SMF failure

When the V-SMF detects the failure of the H-SMF, it shall retrieve all PDU sessions associated with the failed H-SMF and perform the following procedure for those PDU sessions:
if the H-SMF does not support SETFRI feature, the V-SMF shall release affected PDU sessions;
if the H-SMF supports SETFRI feature, the V-SMF may select another H-SMF if V-SMF also supports SETFRI feature, otherwise, the V-SMF shall release the PDU session.
NOTE: The resource related to affected PDU sessions in the HPLMN need not be kept even if the H-SMF supports SMF Set.

FIG. 42b shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 4214 as well as means or modules for accomplishing other processes in conjunction with other components. For some parts which have been described in the above embodiments, the description thereof is omitted here for brevity.

At block 4215, the AMF may obtain third information about whether a resource is exclusively bound to a specific service instance in a first session management function (SMF).

At block 4216, the AMF may obtain fourth information about whether a second SMF supports a reselection of an alternative first SMF instance within an SMF set of the first SMF.

At block 4217. the AMF may detect that the first SMF is failed.

At block 4218, the AMF may reselect an alternative service instance within the SMF set of the first SMF based on the third information and the fourth information.

For example, when the AMF detects the failure of the V-SMF, it shall retrieve all PDU sessions associated with the failed V-SMF and perform the following procedure for those PDU sessions:
if the H-SMF supports the “Peer NF SET based Reselection” (PSETR) feature (e.g., fourth information) and if the V-SMF supports the “Deployed Local SMF Set” (DLSET) feature (e.g., third information), the AMF shall keep the PDU session and should reselect an alternative V-SMF service instance, e.g. when it needs to send any request message to the V-SMF.
if the HI-SMF doesn't support the PSETR feature while the V-SMF supports the DLSET feature, the AMF shall keep the PDU sessions, and may reselect an alternative V-SMF service instance to request the selected alternative V-SMF to delete the PDU session towards the UE and the UPF. The V-SMF may request the UE to reactivate the PDU session.
for any other cases, the AMF may release the affected PDU session(s) locally and/or notify the UE about the release of the PDU session.

In an embodiment, the third information may be a Boolean and/or the fourth information may be a Boolean.

In an embodiment, obtaining the third information may comprise sending a network function (NF) discovery request to a Network Repository Function (NRF) and receiving a NF discovery response comprising the third information from the NRF.

In an embodiment, obtaining the third information may comprise receiving a service response message or a service request message including the third information from the first SMF.

In an embodiment, obtaining the fourth information may comprise sending a NF discovery request to an NRF and receiving a NF discovery response comprising the fourth information from the NRF.

In an embodiment, obtaining the fourth information may comprise receiving an update session management (SM) Context Response message including the fourth information from the first SMF.

In an embodiment, the reselecting an alternative service instance within the SMF set of the first SMF based on the third information and the fourth information may comprise when the third information indicates that the resource is not exclusively bound to the specific service instance in the first SMF, and the fourth information indicates that the second SMF supports the reselection of the alternative first SMF instance within the SMF set of the first SMF, reselecting the alternative V-SMF service instance within the SMF set of the first SMF.

In an embodiment, the reselecting an alternative service instance within the SMF set of the first SMF based on the third information and the fourth information may further comprise when the third information indicates that the resource is not exclusively bound to the specific service instance in the first SMF, and the fourth information indicates that the second SMF doesn't support the reselection of the alternative first SMF instance within the SMF set of the first SMF, reselecting the alternative first SMF service instance within the SMF set of the first SMF and sending a request for deleting at least one affected Protocol Data Unit, PDU, session toward a User Equipment, UE to the alternative first SMF.

In an embodiment, the reselecting an alternative service instance within the SMF set of the first SMF based on the third information and the fourth information may comprise when the third information indicates that the resource is exclusively bound to the specific service instance in the first SMF, releasing at least one affected PDU session without reselecting the alternative first SMF service instance.

In an embodiment, the first SMF may be a visited SMF and the second SMF may be a home SMF or the first SMF may be an intermediate SMF and the second SMF may be an anchor SMF.

FIG. 42c shows a flowchart of a method according to another embodiment of the present disclosure, which may be performed by an apparatus implemented in or at or as an AMF or communicatively coupled to the AMF. As such, the apparatus may provide means or modules for accomplishing various parts of the method 4220 as well as means or modules for accomplishing other processes in conjunction with other components. For some parts which have been described in the above embodiments, the description thereof is omitted here for brevity.

At block 4222, the AMF may obtain fifth information about whether a resource is exclusively bound to a specific service instance in the second SMF.

At block 4224, the AMF may send the fifth information to the first SMF.

FIG. 42d shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 4230 as well as means or modules for accomplishing other processes in conjunction with other components. For some parts which have been described in the above embodiments, the description thereof is omitted here for brevity.

At block 4232, the first SMF may obtain fifth information about whether a resource is exclusively bound to a specific service instance in a second SMF.

At block 4234, the first SMF may obtain sixth information about whether the first SMF supports a reselection of an alternative second SMF instance within an SMF set of the second SMF.

For example, when the V-SMF detects the failure of the H-SMF, it shall retrieve all PDU sessions associated with the failed H-SMF and perform the following procedure for those PDU sessions:
if the V-SMF does not support the PSETR feature (e.g., sixth information), the V-SMF may release the affected PDU sessions towards the AMF and UE, and may request the UE to reactivate the PDU session;
if the V-SMF supports the PSETR feature:
if the HI-SMF supports the DLSET feature (e.g., fifth information), the V-SMF shall keep the PDU session and may reselect an alternative HI-SMF service instance, e.g. when it needs to send any request message to the HI-SMF;
if the H-SMF doesn't support the DLSET feature, the V-SMF may release the PDU session towards the AMF and UE, and the V-SMF may request UE to reactivate the PDU session.

In an embodiment, the fifth information may be obtained from an access and mobility function (AMF) or the second SMF.

FIG. 42c shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 4240 as well as means or modules for accomplishing other processes in conjunction with other components. For some parts which have been described in the above embodiments, the description thereof is omitted here for brevity.

At block 4242, the first SMF may send to an AMF third information about whether a resource is exclusively bound to a specific service instance in the first SMF.

At block 4244, the first SMF may send to the AMF, fourth information about whether a second SMF supports a reselection of an alternative first SMF instance within an SMF set of the first SMF. The third information and the fourth information may be used by the AMF to reselect an alternative service instance within the SMF set of the first SMF when the first SMF is failed.

FIG. 42f shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 4250 as well as means or modules for accomplishing other processes in conjunction with other components. For some parts which have been described in the above embodiments, the description thereof is omitted here for brevity.

At block 4252, the first SMF may obtain the fourth information.

In an embodiment, the first SMF may obtain the fourth information by receiving the fourth information from the second SMF.

In an embodiment, the third information may be included in a service request or response message.

In an embodiment, the fourth information may be included in an update SM context response message.

FIG. 42g shows a flowchart of a method according to another embodiment of the present disclosure, which may be performed by an apparatus implemented in or at or as a first SMF or communicatively coupled to the first SMF. As such, the apparatus may provide means or modules for accomplishing various parts of the method 4260 as well as means or modules for accomplishing other processes in conjunction with other components. For some parts which have been described in the above embodiments, the description thereof is omitted here for brevity.

At block 4262, the first SMF may send the third information to the second SMF.

In an embodiment, the first SMF may be a visited SMF and the second SMF may be a home SMF or the first SMF may be an intermediate SMF and the second SMF may be an anchor SMF.

FIG. 42h shows a flowchart of a method according to another embodiment of the present disclosure, which may be performed by an apparatus implemented in or at or as a second SMF or communicatively coupled to the first SMF. As such, the apparatus may provide means or modules for accomplishing various parts of the method 4270 as well as means or modules for accomplishing other processes in conjunction with other components. For some parts which have been described in the above embodiments, the description thereof is omitted here for brevity.

At block 4272, the second SMF may receive from a first SMF third information about whether a resource is exclusively bound to a specific service instance in the first SMF.

At block 4274, the second SMF may obtain fourth information about whether the second SMF supports a reselection of an alternative first SMF instance within an SMF set of the first SMF.

For example, when the H-SMF detects the failure of the V-SMF, it shall retrieve all PDU sessions associated with the failed V-SMF and perform the following procedure for those PDU sessions:
if the H-SMF supports the PSETR feature (e.g., fourth information):
if the V-SMF supports the DLSET feature (e.g., third information), the H-SMF shall keep the PDU session and should reselect an alternative V-SMF service instance, e.g. when it needs to send any request message to the V-SMF;
if the V-SMF doesn't support the DLSET feature, the H-SMF shall delete the affected PDU sessions locally.
if the H-SMF does not support the PSETR feature:
the H-SMF shall delete the affected PDU sessions.

At block 4276, optionally, the second SMF may send fifth information about whether a resource is exclusively bound to a specific service instance in the second SMF to the first SMF.

In an embodiment, the first SMF may be a visited SMF and the second SMF may be a home SMF or the first SMF may be an intermediate SMF and the second SMF may be an anchor SMF.

FIG. 43 is a block diagram showing an apparatus suitable for practicing some embodiments of the disclosure. For example, any one of the AMF, the first SMF, the second SMF, the third NF, or the NRF described above may be implemented as or through the apparatus 4300.

The apparatus 4300 comprises at least one processor 4321, such as a digital processor (DP), and at least one memory (MEM) 4322 coupled to the processor 4321. The apparatus 4300 may further comprise a transmitter TX and receiver RX 4323 coupled to the processor 4321. The MEM 4322 stores a program (PROG) 4324. The PROG 4324 may include instructions that, when executed on the associated processor 4321, enable the apparatus 4300 to operate in accordance with the embodiments of the present disclosure. A combination of the at least one processor 4321 and the at least one MEM 4322 may form processing means 4325 adapted to implement various embodiments of the present disclosure.

Various embodiments of the present disclosure may be implemented by computer program executable by one or more of the processor 4321, software, firmware, hardware or in a combination thereof.

The MEM 4322 may be of any type suitable to the local technical environment and may be implemented using any suitable data storage technology, such as semiconductor based memory devices, magnetic memory devices and systems, optical memory devices and systems, fixed memories and removable memories, as non-limiting examples.

The processor 4321 may be of any type suitable to the local technical environment, and may include one or more of general purpose computers, special purpose computers, microprocessors, digital signal processors (DSPs) and processors based on multicore processor architecture, as non-limiting examples.

In an embodiment where the apparatus is implemented as or at the AMF, the memory 4322 contains instructions executable by the processor 4321, whereby the AMF operates according to any of the methods related to the AMF as described above.

In an embodiment where the apparatus is implemented as or at the first SMF, the memory 4322 contains instructions executable by the processor 4321, whereby the first SMF operates according to any of the methods related to the first SMF as described above.

In an embodiment where the apparatus is implemented as or at the second SMF, the memory 4322 contains instructions executable by the processor 4321, whereby the second SMF operates according to any of the methods related to the second SMF as described above.

In an embodiment where the apparatus is implemented as or at the third NF, the memory 4322 contains instructions executable by the processor 4321, whereby the third NF operates according to any of the methods related to the third NF as described above.

In an embodiment where the apparatus is implemented as or at the NRF, the memory 4322 contains instructions executable by the processor 4321, whereby the NRF operates according to any of the methods related to the NRF as described above.

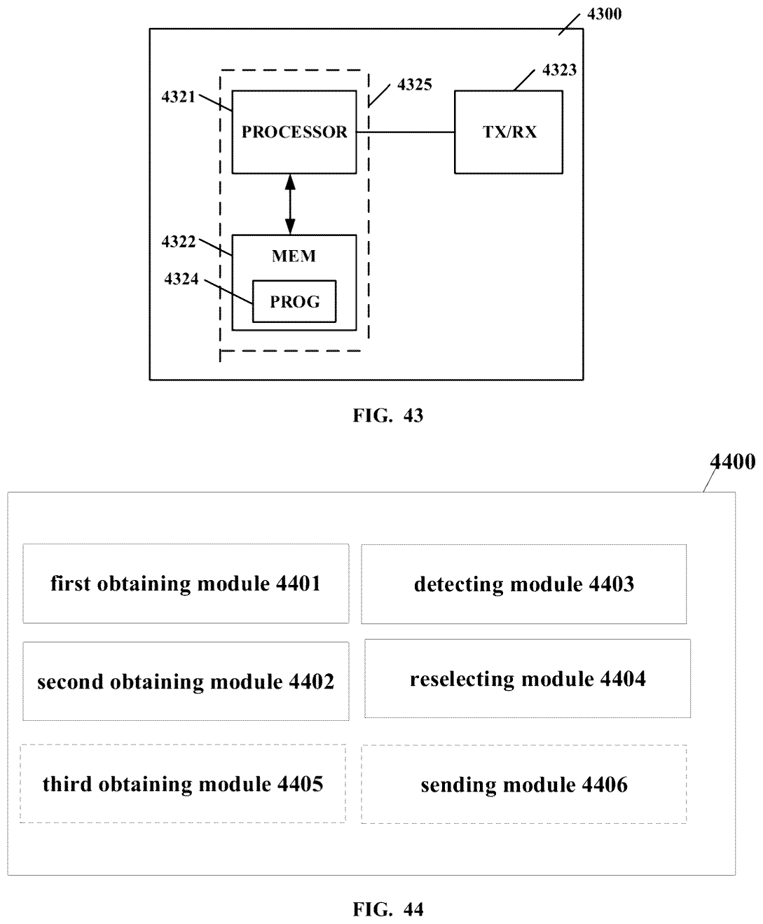

FIG. 44 is a block diagram showing an AMF according to an embodiment of the disclosure. As shown, the AMF 4400 comprises a first obtaining module 4401 configured to obtain third information about whether a resource is exclusively bound to a specific service instance in a first session management function (SMF). In an embodiment, the AMF 4400 may further comprise a second obtaining module 4402 configured to obtain fourth information about whether a second SMF supports a reselection of an alternative first SMF instance within an SMF set of the first SMF. The AMF 4400 may further comprise a detecting module 4403 configured to detect that the first SMF is failed. The AMF 4400 further comprises a reselecting module 4404 configured to reselect an alternative service instance within the SMF set of the first SMF based on the third information and the fourth information.

In an embodiment, the AMF 4400 may further comprise a third obtaining module 4405 configured to obtain fifth information about whether a resource is exclusively bound to a specific service instance in the second SMF.

In an embodiment, the AMF 4400 may further comprise a sending module 4406 configured to send the fifth information to the first SMF.

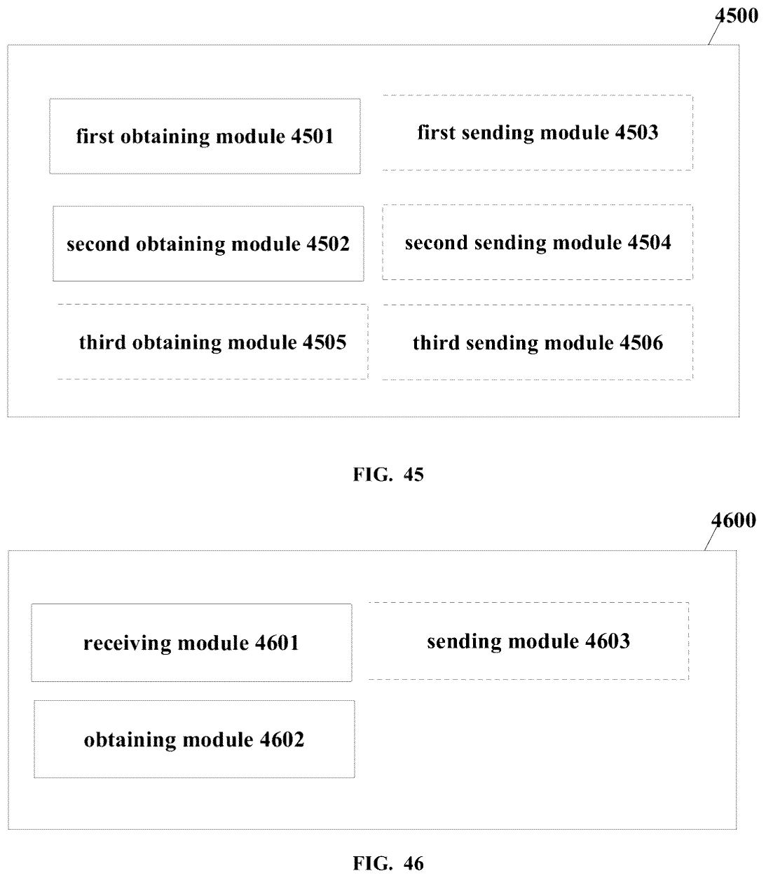

FIG. 45 is a block diagram showing a first SMF according to an embodiment of the disclosure. As shown, the first SMF 4500 may comprise a first sending module 4501 configured to send to an AMF third information about whether a resource is exclusively bound to a specific service instance in the first SMF. The first SMF 4500 may further comprise a second sending module 4502 configured to send to the AMF, fourth information about whether a second SMF supports a reselection of an alternative first SMF instance within an SMF set of the first SMF.

In an embodiment, the third information and the fourth information may be used by the AMF to reselect an alternative service instance within the SMF set of the first SMF when the first SMF is failed.

In an embodiment, the first SMF 4500 may further comprise a first obtaining module 4503 configured to obtain fifth information about whether a resource is exclusively bound to a specific service instance in a second SMF. The first SMF 4500 may further comprise a second obtaining module 4504 configured to obtain sixth information about whether the first SMF supports a reselection of an alternative second SMF instance within an SMF set of the second SMF.

In an embodiment, the first SMF 4500 may further comprise a third obtaining module 4505 configured to obtaining the fourth information.

In an embodiment, the first SMF 4500 may further comprise a third sending module 4506 configured to send the third information to the second SMF.

FIG. 46 is a block diagram showing a second SMF according to an embodiment of the disclosure. As shown, the second SMF 4600 comprises a receiving module 4601 configured to receive from a first SMF third information about whether a resource is exclusively bound to a specific service instance in the first SMF. The second SMF 4600 may further comprise an obtaining module 4602 configured to obtain fourth information about whether the second SMF supports a reselection of an alternative first SMF instance within an SMF set of the first SMF

In an embodiment, the second SMF 4600 may further comprise a sending module 4603 configured to send fifth information about whether a resource is exclusively bound to a specific service instance in the second SMF to the first SMF.

Embodiments herein may provide many advantages, of which a non-exhaustive list of examples follows. In some embodiments herein, it is proposed a restoration procedure to restore

PDU sessions affected by a SMF failure. In some embodiments herein, it may reduce the time to restore PDU sessions affected by a SMF failure. In some embodiments herein, ghost session issue can be solved. In some embodiments herein, service availability can be improved. The embodiments herein are not limited to the features and advantages mentioned above. A person skilled in the art will recognize additional features and advantages upon reading the following detailed description.

The term unit or module may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

With function units, the AMF, the first SMF or the second SMF, may not need a fixed processor or memory, any computing resource and storage resource may be arranged from the AMF, the first SMF or the second SMF in the communication system. The introduction of virtualization technology and network computing technology may improve the usage efficiency of the network resources and the flexibility of the network.

According to an aspect of the disclosure it is provided a computer program product being tangibly stored on a computer readable storage medium and including instructions which, when executed on at least one processor, cause the at least one processor to carry out any of the methods as described above.

According to an aspect of the disclosure it is provided a computer-readable storage medium storing instructions which when executed by at least one processor, cause the at least one processor to carry out any of the methods as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method performed by an access and mobility function (AMF), comprising:
obtaining third information about whether a resource is exclusively bound to a specific service instance in a first session management function (SMF);
obtaining fourth information about whether a second SMF supports a reselection of an alternative first SMF instance within an SMF set of the first SMF;
detecting that the first SMF is failed; and
reselecting an alternative service instance within the SMF set of the first SMF based on the third information and the fourth information.

2. The method according to claim 1, wherein the third information is a Boolean and/or the fourth information is a Boolean.

3. The method according to claim 1, wherein obtaining the third information comprises:
sending a network function (NF) discovery request to a Network Repository Function (NRF) and receiving a NF discovery response comprising the third information from the NRF; or
receiving a service response message or a service request message including the third information from the first SMF.

4. (canceled)

5. The method according to claim 1, wherein obtaining the fourth information comprises:
sending a NF discovery request to an NRF, and receiving a NF discovery response comprising the fourth information from the NRF; or
receiving an update session management (SM) Context Response message including the fourth information from the first SMF.

6. (canceled)

7. The method according to claim 1, wherein the reselecting an alternative service instance within the SMF set of the first SMF based on the third information and the fourth information comprises:
when the third information indicates that the resource is not exclusively bound to the specific service instance in the first SMF, and the fourth information indicates that the second SMF supports the reselection of the alternative first SMF instance within the SMF set of the first SMF, reselecting the alternative V-SMF service instance within the SMF set of the first SMF.

8. The method according to claim 1, wherein the reselecting an alternative service instance within the SMF set of the first SMF based on the third information and the fourth information comprises:
when the third information indicates that the resource is not exclusively bound to the specific service instance in the first SMF, and the fourth information indicates that the second SMF doesn't support the reselection of the alternative first SMF instance within the SMF set of the first SMF,
reselecting the alternative first SMF service instance within the SMF set of the first SMF; and
sending a request for deleting at least one affected Protocol Data Unit (PDU) session toward a User Equipment (UE) to the alternative first SMF.

9. The method according to claim 1, wherein the reselecting an alternative service instance within the SMF set of the first SMF based on the third information and the fourth information comprises:
when the third information indicates that the resource is exclusively bound to the specific service instance in the first SMF, releasing at least one affected PDU session without reselecting the alternative first SMF service instance.

10. The method according to claim 1, wherein the first SMF is a visited SMF and the second SMF is a home SMF or the first SMF is an intermediate SMF and the second SMF is an anchor SMF.

11. The method according to claim 1, further comprising:
obtaining fifth information about whether a resource is exclusively bound to a specific service instance in the second SMF; and
sending the fifth information to the first SMF.

12. A method performed by a first session management function (SMF), comprising:
sending to an AMF third information about whether a resource is exclusively bound to a specific service instance in the first SMF;
sending to the AMF fourth information about whether a second SMF supports a reselection of an alternative first SMF instance within an SMF set of the first SMF;
wherein the third information and the fourth information are used by the AMF to reselect an alternative service instance within the SMF set of the first SMF when the first SMF is failed.

13. The method according to claim 12, the method further comprises:
obtaining the fourth information;
wherein the obtaining the fourth information comprises receiving the fourth information from the second SMF.

14. (canceled)

15. The method according to claim 12, further comprising:
sending the third information to the second SMF.

16. The method according to claim 12, wherein the third information is included in a service request or response message.

17. The method according to claim 12, wherein the fourth information is included in an update SM context response message.

18. The method according to claim 12, wherein the first SMF is a visited SMF and the second SMF is a home SMF or the first SMF is an intermediate SMF and the second SMF is an anchor SMF.

19. The method according to claim 12, the method further comprises:
obtaining fifth information about whether a resource is exclusively bound to a specific service instance in the second SMF; and
obtaining sixth information about whether the first SMF supports a reselection of an alternative second SMF instance within an SMF set of the second SMF.

20. The method according to claim 19, wherein the fifth information is obtained from an access and mobility function (AMF) or the second SMF.

21. A method performed by a second session management function (SMF), comprising:
receiving from a first SMF third information about whether a resource is exclusively bound to a specific service instance in the first SMF; and
obtaining fourth information about whether the second SMF supports a reselection of an alternative first SMF instance within an SMF set of the first SMF.

22. The method according to claim 21, further comprising:
sending fifth information about whether a resource is exclusively bound to a specific service instance in the second SMF to the first SMF.

23. The method according to claim 21, wherein the first SMF is a visited SMF and the second SMF is a home SMF or the first SMF is an intermediate SMF and the second SMF is an anchor SMF.

24. An access and mobility function (AMF), comprising:
a processor; and
a memory coupled to the processor, said memory containing instructions executable by said processor, whereby said AMF is operative to:
obtain third information about whether a resource is exclusively bound to a specific service instance in a first session management function (SMF);
obtain fourth information about whether a second SMF supports a reselection of an alternative first SMF instance within an SMF set of the first SMF;
detect that the first SMF is failed; and
reselect an alternative service instance within the SMF set of the first SMF based on the third information and the fourth information.

25. The AMF according to claim 24, wherein the AMF is operative to reselect an alternative service instance within the SMF set of the first SMF based on the third information and the fourth information by:
when the third information indicates that the resource is not exclusively bound to the specific service instance in the first SMF, and the fourth information indicates that the second SMF supports the reselection of the alternative first SMF instance within the SMF set of the first SMF reselecting the alternative V-SMF service instance within the SMF set of the first SMF, or
when the third information indicates that the resource is not exclusively bound to the specific service instance in the first SMF, and the fourth information indicates that the second SMF doesn't support the reselection of the alternative first SMF instance within the SMF set of the first SMF, reselect be alternative first SMF service instance within the SMF set of the first SMF, and sending a request for deleting at least one affected Protocol Data Unit (PDU) session toward a User Equipment (UE) to the alternative first SMF; or
when the third information indicates that the resource is exclusively bound to the specific service in the first SMF, releasing at least one affected PDU session without reselecting the alternative first SMF service instance.

26. A first session management function (SMF), comprising:
a processor; and
a memory coupled to the processor, said memory containing instructions executable by said processor, whereby said first SMF is operative to:
send to an AMF third information about whether a resource is exclusively bound to a specific service instance in the first SMF;
send to the AMF fourth information about whether a second SMF supports a reselection of an alternative first SMF instance within an SMF set of the first SMF;
wherein the third information and the fourth information are used by the AMF to reselect an alternative service instance within the SMF set of the first SMF when the first SMF is failed.

27. The first SMF according to claim 26, wherein:
the third information is included in a service request or response message; and/or
the fourth information is included in an update SM context response message.

28. A second session management function (SMF), comprising:
a processor; and
a memory coupled to the processor, said memory containing instructions executable by said processor, whereby said second SMF is operative to:
receive from a first SMF third information about whether a resource is exclusively bound to a specific service instance in the first SMF; and
obtain fourth information about whether the second SMF supports a reselection of an alternative first SMF instance within an SMF set of the first SMF.

29. The second SMF according to claim 28, wherein the first SMF is a visited SMF and the second SMF is a home SMF or the first SMF is an intermediate SMF and the second SMF is an anchor SMF.

30. (canceled)

31. (canceled)
